(19) United States
(12) Patent Application Publication
(10) Pub. No.: US 2011/0245003 A1
(43) Pub. Date: Oct. 6, 2011

(54) HYBRID DRIVE DEVICE

(75) Inventor: Shigeki TAKAMI, Anjo (JP)

(73) Assignee: AISIN AW CO., LTD., Anjo-shi (JP)

(21) Appl. No.: 13/014,891

(22) Filed: Jan. 27, 2011

(30) Foreign Application Priority Data
Mar. 31, 2010 (JP) 2010-080562

(51) Int. Cl. B60K 6/365; B60K 6/42

(52) U.S. Cl. 475/5; 180/65.22; 180/65.21; 903/902

(57) ABSTRACT

A hybrid drive device that switchably includes a first split mode in which an input and output rotary element are drivably coupled to each other, and a second split mode in which the speed change input rotary element and a distribution input rotary element are drivably coupled to each other. The first and second relative rotational speed ratios are set at different values such that the first ratio is a ratio of a relative rotational speed of the distribution input rotary element to a relative rotational speed of the output rotary element determined on the basis of a rotational speed of a reaction force rotary element, and the second ratio being a ratio of a relative rotational speed of the second output rotary element to a relative rotational speed of the first output rotary element determined on the basis of a speed of the fixed rotary element.

### INCORPORATION BY REFERENCE

The disclosure of Japanese Patent Application No. 2010-080562 filed on Mar. 31, 2010, including the specification, drawings and abstract is incorporated herein by reference in its entirety.

### BACKGROUND OF THE INVENTION

The present invention relates to a hybrid drive device for use in a hybrid vehicle including two rotary electric machines as drive force sources in addition to an internal combustion engine.

### DESCRIPTION OF THE RELATED ART

In recent years, hybrid vehicles that use an internal combustion engine and a rotary electric machine as drive force sources to improve the fuel efficiency of the internal combustion engine and to reduce exhaust gas emitted from the internal combustion engine have been in practical use. As an exemplary drive device for use in such hybrid vehicles, Japanese Patent Application Publication No. JP-A-2008-120139 below discloses a so-called split type hybrid drive device in which a power distribution device distributes a drive force from an internal combustion engine to an output member side and a first rotary electric machine side, for example. In the hybrid drive device, as shown in FIGS. 1 and 2 of Japanese Patent Application Publication No. JP-A-2008-120139, an internal combustion engine 1, a first rotary electric machine 2, and an output member 5 are coupled to rotary elements of a power distribution mechanism 4 that performs differential action through at least three rotary elements. In the hybrid drive device, in addition, the output member 5 is coupled to an output side of a speed change mechanism 6 that can provide at least two (high and low) speed change ratios, a second rotary electric machine 3 is coupled to an input side of the speed change mechanism 6, and a clutch mechanism 8 that selectively couples the internal combustion engine 1 and the second rotary electric machine 3 to each other is provided. This allows the hybrid drive device to operate in various operation modes and to provide a good power transfer efficiency.

The operation mode of the hybrid drive device disclosed in Japanese Patent Application Publication No. JP-A-2008-120139 is sequentially switched, along with an increase in vehicle speed, from a mode in which power distributed from the internal combustion engine 1 and power from the second rotary electric machine 3 which has been reduced in speed are directly transferred to the output member 5 with the clutch mechanism 8 in the disengaged state, a mechanical direct coupling mode, which is also referred to as a parallel mode, and an output split mode used in a so-called overdrive state in which the output member speed is higher than the engine speed. In the thus configured hybrid drive device, the clutch mechanism 8 is provided to suppress power circulation that occurs when the second rotary electric machine 3 generates electric power and the first rotary electric machine 2 performs power running in the output split mode.

In the hybrid drive device, the clutch mechanism 8 is formed by a meshing type engagement mechanism. In addition, as described in paragraph [0062] of Japanese Patent Application Publication No. JP-A-2008-120139, “switching to the output split mode is performed by bringing the speed change mechanism 6 to a neutral state with the rotational speed of the first motor/generator 2 being zero or close to zero, and thereafter engaging the clutch mechanism 8 when the second motor/generator 3 and the engine rotate in synchronization with each other”.

### SUMMARY OF THE INVENTION

That is, in order to switch the second rotary electric machine between the output member side and the input rotary element side (engine side) of the power distribution device in the device disclosed in Japanese Patent Application Publication No. JP-A-2008-120139, it is necessary to bring a transmission device provided between the second rotary electric machine and the output member to the neutral state and thereafter synchronize the second rotary electric machine with the input rotary element of the power distribution device to engage the clutch mechanism. In such operation, however, a shock or a drive force interruption may occur during mode switching, which may give an uncomfortable feeling to a driver of the vehicle.

Thus, there is desired a hybrid drive device that can suppress occurrence of power circulation and that reduces occurrence of a shock and a drive force interruption during mode switching.

In order to achieve the foregoing, a hybrid drive device according to a first aspect of the present invention includes an input member drivably coupled to an internal combustion engine, an output member drivably coupled a wheel, a first rotary electric machine, a second rotary electric machine, and a power distribution device including at least three rotary elements, and in which a distribution input rotary element, a reaction force rotary element, and an output rotary element of the power distribution device are drivably coupled to the input member, the first rotary electric machine, and the output member, respectively. The hybrid drive device is characteristically configured to include a transmission device including at least four rotary elements forming a sequence of a speed change input rotary element, a first output rotary element, a second output rotary element, and a fixed rotary element when arranged in the order of rotational speed. In the hybrid drive device, the speed change input rotary element is drivably coupled to the second rotary electric machine, and the fixed rotary element is always or selectively fixed to a non-rotary member. The hybrid drive device switchably includes a first split mode in which the speed change input rotary element and the output rotary element are drivably coupled to each other via the first output rotary element, and a second split mode in which the speed change input rotary element and the distribution input rotary element are drivably coupled to each other via the second output rotary element. A first relative rotational speed ratio and a second relative rotational speed ratio are set to be different from each other. The first relative rotational speed ratio is a ratio of a relative rotational speed of the distribution input rotary element to a relative rotational speed of the output rotary element determined on the basis of a rotational speed of the reaction force rotary element, and the second relative rotational speed ratio is a ratio of a relative rotational speed of the second output rotary element to a relative rotational speed of the first output rotary element determined on the basis of a rotational speed of the fixed rotary element.

The term “drivably coupled” as used herein refers to a state in which two rotary elements are coupled to each other in such a way that allows transfer of a drive force, which includes a state in which the two rotary elements are coupled to each other to rotate together, and a state in which the two rotary elements are coupled to each other via one or two or more transmission members in such a way that allows transfer of a drive force. Examples of such transmission members include various members that transfer rotation at an equal speed or a changed speed, such as a shaft, a gear mechanism, a belt, and a chain. In the case where rotary elements of a differential gear mechanism (device) that performs differential action are “drivably coupled” to each other, however, it is intended that a plurality of rotary elements provided in the differential gear mechanism are drivably coupled to each other via no other rotary element.

The term “rotary electric machine” refers to any of a motor (electric motor), a generator (electric generator), and a motor generator that functions as both a motor and a generator as necessary.

The term “order of rotational speed” may refer to either of an order from the high speed side to the low speed side and an order from the low speed side to the high speed side depending on the rotating state of each differential gear mechanism. In either case, the order of the rotary elements is invariable.

According to the first aspect, the power distribution device can distribute a drive force transferred from the internal combustion engine to the power distribution device via the input member to the first rotary electric machine and the output member side. The hybrid drive device according to this aspect of the present invention further includes a transmission device including at least four rotary elements forming a sequence of a speed change input rotary element, a first output rotary element, a second output rotary element, and a fixed rotary element when arranged in the order of rotational speed, and the speed change input rotary element of the transmission device is drivably coupled to the second rotary electric machine, and the fixed rotary element of the transmission device is always or selectively fixed to a non-rotary member. Rotation of the second rotary electric machine is transferred, after being reduced in speed, to the first output rotary element or the second output rotary element, of the at least two rotary elements of the transmission device other than the speed change input rotary element and the fixed rotary element. That is, the speed change input rotary element and the output rotary element are drivably coupled to each other via the first output rotary element in the first split mode, and the speed change input rotary element and the distribution input rotary element are drivably coupled to each other via the second output rotary element in the second split mode.

In other words, the hybrid drive device switchably includes the first split mode in which rotation which has been reduced in speed relative to the rotational speed of the speed change input rotary element is transferred to the output rotary element of the power distribution device via the first output rotary element, and the second split mode in which rotation which has been reduced in speed relative to the rotational speed of the speed change input rotary element at a speed change ratio (speed reduction ratio) higher than that in the first split mode is transferred to the distribution input rotary element of the power distribution device via the second output rotary element. In the first split mode, rotation of the second rotary electric machine which has been reduced in speed is directly transferred to the output member via the first output rotary element of the transmission device and the output rotary element of the power distribution device. In the second split mode, meanwhile, rotation of the second rotary electric machine which has been reduced in speed is directly transferred to the input member via the second output rotary element of the transmission device and the distribution input rotary element of the power distribution device. In other words, rotation of the input member which has been increased in speed is directly transferred to the second rotary electric machine via the distribution input rotary element of the power distribution device and the second output rotary element of the transmission device.

Thus, provided with the second split mode, the hybrid drive device of the first aspect of the present invention can suppress occurrence of power circulation. That is, in the second split mode, the drive force of the internal combustion engine is directly transferred to the second rotary electric machine even when the first rotary electric machine performs power running and the second rotary electric machine generates electric power while the vehicle is running at a high speed. Thus, occurrence of power circulation can be suppressed by preventing a drive force generated by the power running performed by the first rotary electric machine from being used in the electric power generation performed by the second rotary electric machine. In this event, in addition, rotation from the second rotary electric machine which has been reduced in speed is transferred to the distribution input rotary element of the power distribution device not via the output member. Accordingly, part of the drive force of the internal combustion engine is offset by torque of the second rotary electric machine, and thus the drive force to be output by the first rotary electric machine in order to receive a reaction force against the drive force of the internal combustion engine can be reduced in the second split mode. Thus, only a small proportion of the drive force of the internal combustion engine is converted into electric power, which improves the energy efficiency of the hybrid drive device.

In the power distribution device, further, along with a rise in vehicle speed, rotation of the first rotary electric machine changes from positive rotation to negative rotation, rotation of the reaction force rotary element also changes from positive rotation to negative rotation, and rotation of the output rotary element of the power distribution device also changes. Thus, by correlating the first output rotary element and the second output rotary element, of the remaining rotary elements of the transmission device other than the speed change input rotary element and the fixed rotary element, with the output rotary element and the distribution input rotary element of the power distribution device, both the transmission device and the power distribution device can be synchronized with each other. Then, in the case where mode switching is to be performed with both the devices synchronized with each other, it is no longer necessary to bring the transmission device to the neutral state, and occurrence of a shock and a drive force interruption during mode switching can be suppressed.

Thus, according to the above first aspect, a hybrid drive device that can suppress occurrence of power circulation and that reduces occurrence of a shock and a drive force interruption during mode switching can be provided.

If mode switching is to be performed only at a switching point at which the transmission device and the power distribution device are synchronized with each other, however, mode switching may be performed frequently in a short period of time around the switching point depending on the running state of the vehicle. In this case, a sense of busyness (an impression of being in a hurry) may be given to a driver of the vehicle.

In this respect, according to the above first aspect, the first relative rotational speed ratio and the second relative rotational speed ratio are set to be different from each other. The output rotary element of the power distribution device and the first output rotary element of the transmission device are drivably coupled to each other when the first split mode is established, and the distribution input rotary element of the power distribution device and the second output rotary element of the transmission device are drivably coupled to each other when the second split mode is established. Accordingly, according to the above characteristic configuration, the relative rotational speed of the reaction force rotary element and the relative rotational speed of the fixed rotary element, on the basis of the output rotary element and the first output rotary element, or the distribution input rotary element and the second output rotary element, are different from each other. Therefore, it is possible to set, as switching points for mode switching, an operating point at which both the devices are synchronized with each other and an operating point at which the devices are not synchronized with each other but torque of the second rotary electric machine becomes zero, for example. Thus, hysteresis can be provided in mode switching between the first split mode and the second split mode. Accordingly, it is possible to prevent mode switching from being performed frequently in a short period of time, and to avoid giving the driver of the vehicle a sense of busyness. If mode switching is performed at the operating point at which both the devices are synchronized with each other, it is no longer necessary to bring the transmission device to the neutral state, and occurrence of a drive force interruption during mode switching can be suppressed. If mode switching is performed at the operating point at which torque of the second rotary electric machine becomes zero, transfer of variations in torque to the output member side can be suppressed to suppress generation of a shock during mode switching.

The settings of the first relative rotational speed ratio and the second relative rotational speed ratio can be adjusted by appropriately setting the relationship of the numbers of teeth of the rotary elements provided in the power distribution device and the transmission device.

Thus, according to the above first aspect, a hybrid drive device that can suppress occurrence of power circulation, that reduces occurrence of a shock and a drive force interruption during mode switching, and that is unlikely to give the driver a sense of busyness due to mode switching can be provided.

According to a second aspect, the hybrid drive device may further include a first split mode engagement device that is brought to an engaged state to establish the first split mode, and a second split mode engagement device that is engaged to establish the second split mode. In the hybrid drive device, defining an operating point at which rotational speeds of engagement members on both sides of one of the first split mode engagement device and the second split mode engagement device that is to be engaged in mode switching are equal to each other as a rotation synchronization point, and defining an operating point at which torque of the second rotary electric machine becomes zero as a zero torque point, mode switching from the first split mode to the second split mode may be performed at one of the rotation synchronization point and the zero torque point, and mode switching from the second split mode to the first split mode may be performed at the other of the rotation synchronization point and the zero torque point.

At the rotation synchronization point, the rotational speeds of the engagement members on both sides of the engagement device that is to be brought to the engaged state to establish a target mode are equal to each other. Thus, if mode switching is performed at the rotation synchronization point, it is no longer necessary to bring the transmission device to the neutral state, and occurrence of a drive force interruption during mode switching can be suppressed. If mode switching is performed at the zero torque point at which torque of the second rotary electric machine becomes zero, transfer of variations in torque to the output member side can be suppressed to suppress generation of a shock during mode switching.

According to the second aspect, mode switching from the first split mode to the second split mode can be performed while suppressing generation of a drive force interruption, and mode switching from the second split mode to the first split mode can be performed while suppressing generation of a shock. Alternatively, mode switching from the first split mode to the second split mode can be performed while suppressing generation of a shock, and mode switching from the second split mode to the first split mode can be performed while suppressing generation of a drive force interruption.

According to the hybrid drive device of the above aspects of the present invention with the first relative rotational speed ratio and the second relative rotational speed ratio set to be different from each other, moreover, mode switching performed at the rotation synchronization point and mode switching performed at the zero torque point can be reliably performed at different switching points. Accordingly, hysteresis can be reliably provided in mode switching between the first split mode and the second split mode. Thus, it is possible to appropriately avoid giving the driver of the vehicle a sense of busyness due to mode switching.

According to a third aspect, at least the second split mode engagement device which is brought to the engaged state to establish the second split mode may be a two-way engagement device that switchably includes at least two states including a state in which rotation of the engagement member on one side of the second split mode engagement device relative to the engagement member on the other side is allowed in both directions and a state in which such rotation is allowed only in one direction and restricted in the other direction.

According to the third aspect, the second split mode can be established appropriately by appropriately engaging the second split mode engagement device by bringing the second split mode engagement device to a state in which rotation is allowed only in an appropriate one of the positive direction and the negative direction and restricted in the other direction depending on the direction of the drive force applied to one or both of the rotary elements drivably coupled to the engagement members on both sides of the second split mode engagement device. In this event, mode switching can be performed quickly without synchronizing rotations of the engagement members on both sides of the second split mode engagement device, by initially establishing a state in which rotation of the engagement member on one side of the second split mode engagement device relative to the engagement member on the other side is allowed only in an appropriate one of the positive direction and the negative direction and finally engaging the second split mode engagement device.

In addition, a configuration in which the need for a hydraulic pressure for generating an engagement pressure or a disengagement pressure is eliminated can easily be achieved, compared to a case where a friction engagement device is used as the second split mode engagement device, for example. Therefore, a loss of a drive force due to a hydraulic pressure pump can be suppressed, which facilitates improving the transfer efficiency of the drive device. In the case where the hybrid drive device according to the present invention is formed by adding a configuration for establishing the second split mode to an existing hybrid drive device in which rotation of the second rotary electric machine is transferred to the output member via the transmission device, moreover, it is not necessary to additionally provide an oil passage for supplying a hydraulic pressure to the second split mode engagement device, and therefore changes to be made to a case and so forth can be minimized. It is further preferred that the second split mode engagement device performs operation of switching between at least two states including a state in which rotation of the engagement member on one side of the engagement device relative to the engagement member on the other side is allowed in both directions and a state in which such rotation is allowed only in One direction and restricted in the other direction through an electromagnetic actuator, for example, in order to completely eliminate the need to supply a hydraulic pressure.

According to a fourth aspect, the second split mode engagement device may be switchable between a two-way allowing state in which rotation of the fixed rotary element relative to a non-rotary member is allowed in both directions and a positive-direction restricting state in which such rotation is allowed only in a negative direction and restricted in a positive direction, and mode switching from the first split mode to the second split mode may be performed by switching the second split mode engagement device from the two-way allowing state to the positive-direction restricting state with the fixed rotary element rotating in the negative direction.

This configuration in the fourth aspect is suitable for a case where the second split mode engagement device is formed as a two-way brake. In the case where the second split mode is established with the second split mode engagement device selectively fixing the fixed rotary element to a non-rotary member in the state where the first split mode engagement device, which is brought to the engaged state to establish the first split mode, is disengaged, the fixed rotary element is urged to rotate in the positive direction with the second rotary electric machine generating electric power by outputting a drive force in the negative direction while rotating in the positive direction.

According to the configuration of the fourth aspect, the second split mode can be established appropriately by appropriately fixing the fixed rotary element, which is urged to rotate in the positive direction, to a non-rotary member by the second split mode engagement device which has been brought to the positive-direction restricting state. Moreover, mode switching can be performed quickly without controlling the rotational speed of the fixed rotary element so as to converge to zero.

According to the configuration of the fourth aspect, in addition, one of the engagement members on both sides of the second split mode engagement device is a non-rotary member, and thus the second split mode engagement device, which is formed as a two-way engagement device having a relatively complicated mechanism, can be incorporated in the hybrid drive device easily.

It is also preferred that the second split mode engagement device is switchable between a two-way allowing state in which rotation of the second output rotary element relative to the distribution input rotary element is allowed in both directions and a negative-direction restricting state in which such rotation is allowed only in a positive direction and restricted in a negative direction, and that mode switching from the first split mode to the second split mode is performed by switching the second split mode engagement device from the two-way allowing state to the negative-direction restricting state with the second output rotary element rotating in the positive direction relative to the distribution input rotary element.

This configuration is suitable for a case where the second split mode engagement device is formed as a two-way clutch. In the case where the second split mode is established with the second split mode engagement device selectively drivably coupling the second output rotary element and the distribution input rotary element to each other in the state where the first split mode engagement device, which is brought to the engaged state to establish the first split mode, is disengaged, the second output rotary element is urged to rotate in the negative direction relative to the distribution input rotary element with the second rotary electric machine generating electric power by outputting a drive force in the negative direction while rotating in the positive direction.

According to the configuration, the second split mode can be established appropriately by appropriately drivably coupling the second output rotary element, which is urged to rotate in the negative direction relative to the distribution input rotary element, to the distribution input rotary element to rotate together with the distribution input rotary element by the second split mode engagement device which has been brought to the negative-direction restricting state. Moreover, mode switching can be performed quickly without controlling the rotational speed of the second output rotary element so as to match the rotational speed of the distribution input rotary element.

According to a fifth aspect, the hybrid drive device may further include a third split mode in which the speed change input rotary element and the output rotary element are drivably coupled to each other via the first output rotary element, and in which rotation of the speed change input rotary element is reduced in speed at a speed change ratio higher than that in the first split mode and then transferred to the output rotary element.

According to the fifth aspect, the third split mode in which the speed change input rotary element of the transmission device and the output rotary element of the power distribution device are drivably coupled to each other via the first output rotary element as in the first split mode, and in which rotation of the speed change input rotary element is reduced in speed at a speed change ratio higher than that in the first split mode and transferred to the output rotary element can be established. Thus, in a split mode in which rotation of the second rotary electric machine is transferred to the output member, torque of the second rotary electric machine can be amplified, compared to that in the first split mode, and transferred to the output member. Accordingly, the vehicle can be driven with a larger drive force, or the size of the second rotary electric machine can be reduced while securing the same drive force.

The hybrid drive device according to a sixth aspect of the present invention may be specifically configured such that the transmission device is formed by a first differential gear device including four rotary elements forming a sequence of a first rotary element, a second rotary element, a third rotary element, and a fourth rotary element when arranged in the order of rotational speed, and a second differential gear device including three rotary elements forming a sequence of a first rotary element, a second rotary element, and a third rotary element when arranged in the order of rotational speed, the third rotary element of the first differential gear device is drivably coupled to the output member, the fourth rotary element of the first differential gear device is drivably coupled to the second rotary electric machine, the second rotary element of the second differential gear device is drivably coupled to the input member, the third rotary element of the second differential gear device is drivably coupled to the second rotary electric machine, and the hybrid drive device further includes: a first engagement device that selectively fixes the first rotary element of the first differential gear device to a non-rotary member; a second engagement device that selectively fixes the first rotary element of the second differential gear device to a non-rotary member; and a third engagement device that selectively fixes the second rotary element of the first differential gear device to a non-rotary member.

In the sixth aspect, the fixed rotary element of the transmission device is selectively fixed, and the third split mode can be further established in addition to the first split mode and the second split mode.

That is, according to the sixth aspect, the first split mode can be established by causing the first engagement device to fix the first rotary element of the first differential gear device and bringing the second engagement device and the third engagement device to the disengaged state. On the other hand, the second split mode can be established by causing the second engagement device to fix the first rotary element of the second differential gear device and bringing the first engagement device and the third engagement device to the disengaged state. Moreover, the third split mode can be established by causing the third engagement device to fix the second rotary element of the first differential gear device and bringing the first engagement device and the second engagement device to the disengaged state. Thus, in this configuration, the three split modes can be easily switchably established by appropriately setting the states of the three engagement devices.

Also in this case, the first relative rotational speed ratio and the second relative rotational speed ratio are set to be different from each other. Thus, as has been described so far, it is possible to suppress occurrence of power circulation, suppress occurrence of a shock and a drive force interruption during mode switching, and further avoid giving the driver of the vehicle a sense of busyness due to mode switching.

In the above six aspect, according to a seventh aspect, the first differential gear device may be a Ravigneaux type planetary gear device including four rotary elements forming a sequence of a first sun gear, a common carrier, a common ring gear, and a second sun gear when arranged in the order of rotational speed, and the first rotary element, the second rotary element, the third rotary element, and the fourth rotary element of the first differential gear device correspond to the second sun gear, the common ring gear, the common carrier, and the first sun gear, respectively, and the second differential gear device may be a single-pinion type planetary gear device including a ring gear, a carrier, and a sun gear corresponding to the first rotary element, the second rotary element, and the third rotary element, respectively, of the second differential gear device.

According to the seventh aspect, a compact and reliable hybrid drive device can be provided by adopting a Ravigneaux type planetary gear device for the first differential gear device which forms part of the transmission device.

The term “Ravigneaux type planetary gear device” as used herein refers to a device in which a single-pinion type planetary gear mechanism and a double-pinion type planetary gear device share a carrier and a ring gear.

Alternatively, according to an eighth aspect, the transmission device may be a differential gear device including four rotary elements forming a sequence of a first rotary element, a second rotary element, a third rotary element, and a fourth rotary element when arranged in the order of rotational speed, the first rotary element of the differential gear device may be fixed to a non-rotary member, and the fourth rotary element of the differential gear device may be drivably coupled to the second rotary electric machine. The hybrid drive device may further include: a first engagement device that selectively drivably couples the third rotary element of the differential gear device and the output member to each other; and a second engagement device that selectively drivably couples the second rotary element of the differential gear device and the input member to each other.

In the eighth aspect, the fixed rotary element of the transmission device is always fixed, and the first split mode and the second split mode can be established.

That is, according to the eighth aspect, the first split mode can be established by causing the first engagement device to drivably couple the third rotary element of the differential gear device and the output member to each other, and causing the second engagement device to decouple the second rotary element of the differential gear device and the input member from each other. On the other hand, the second split mode can be established by causing the first engagement device to decouple the third rotary element of the differential gear device and the output member from each other, and causing the second engagement device to drivably couple the second rotary element of the differential gear device and the input member to each other. Thus, in this configuration, the two split modes can be easily switchably established by appropriately setting the states of the two engagement devices. The term “decoupled” refers to a state of being not “drivably coupled”, that is, a state in which no drive force is transferred between two rotary elements.

Also in this case, the first relative rotational speed ratio and the second relative rotational speed ratio are set to be different from each other. Thus, as has been described so far, it is possible to suppress occurrence of power circulation, suppress occurrence of a shock and a drive force interruption during mode switching, and further avoid giving the driver of the vehicle a sense of busyness due to mode switching.

In the above eighth aspect, according to a ninth aspect, the transmission device may be a Ravigneaux type planetary gear device including four rotary elements forming a sequence of a first sun gear, a common carrier, a common ring gear, and a second sun gear when arranged in the order of rotational speed, and the first rotary element, the second rotary element, the third rotary element, and the fourth rotary element of the transmission device may be the first sun gear, the common carrier, the common ring gear, and the second sun gear, respectively.

According to the ninth aspect, a compact and reliable hybrid drive device can be provided by adopting a Ravigneaux type planetary gear device for the transmission device.

In any of the above aspects, according to a tenth aspect, the first relative rotational speed ratio may be set to be higher than the second relative rotational speed ratio.

According to the tenth aspect, in the case where mode switching is performed at an operating point at which torque of the second rotary electric machine becomes zero (the power distribution device and the transmission device are not synchronized with each other), the range of variations in rotational speed of the second rotary electric machine during mode switching can be suppressed compared to a case where the first relative rotational speed ratio is set to be lower than the second relative rotational speed ratio. Accordingly, it is possible to suppress generation of a shock by suppressing transfer of variations in rotational speed of the second rotary electric machine and the speed change input rotary element, which rotate together with each other, to the output rotary element and the output member, which rotate together with each other.

### BRIEF DESCRIPTION OF THE DRAWINGS

FIG. 1 is a skeleton diagram showing the configuration of a hybrid drive device according to a first embodiment;

FIG. 2 is a schematic diagram showing the system configuration of the hybrid drive device according to the first embodiment;

FIG. 3 is an operation table showing the operating state of a plurality of engagement devices in each mode according to the first embodiment;

FIG. 4 is a schematic diagram showing an exemplary control map according to the first embodiment;

FIG. 5 is a velocity diagram for a first split mode according to the first embodiment;

FIG. 6 is a velocity diagram for a second split mode according to the first embodiment;

FIG. 7 is a velocity diagram for a third split mode according to the first embodiment;

FIG. 8 is a time chart showing the process of mode switching between the first split mode and the second split mode according to the first embodiment;

FIG. 9 is a velocity diagram showing the state at a switching point from the first split mode to the second split mode according to the first embodiment;

FIG. 10 is a velocity diagram showing the process of mode switching from the first split mode to the second split mode according to the first embodiment;

FIG. 11 is a velocity diagram showing the state at a switching point from the second split mode to the first split mode according to the first embodiment;

FIG. 12 is a skeleton diagram showing the configuration of a hybrid drive device according to a second embodiment;

FIG. 13 is an operation table showing the operating state of a plurality of engagement devices in each mode according to the second embodiment;

FIG. 14 is a velocity diagram for a first split mode according to the second embodiment;

FIG. 15 is a velocity diagram for a second split mode according to the second embodiment;

FIG. 16 is a skeleton diagram showing the configuration of a hybrid drive device according to other embodiment; and

FIG. 17 is a velocity diagram of the hybrid drive device in a second split mode according to the other embodiment.

### DETAILED DESCRIPTION OF THE EMBODIMENTS

1. First Embodiment

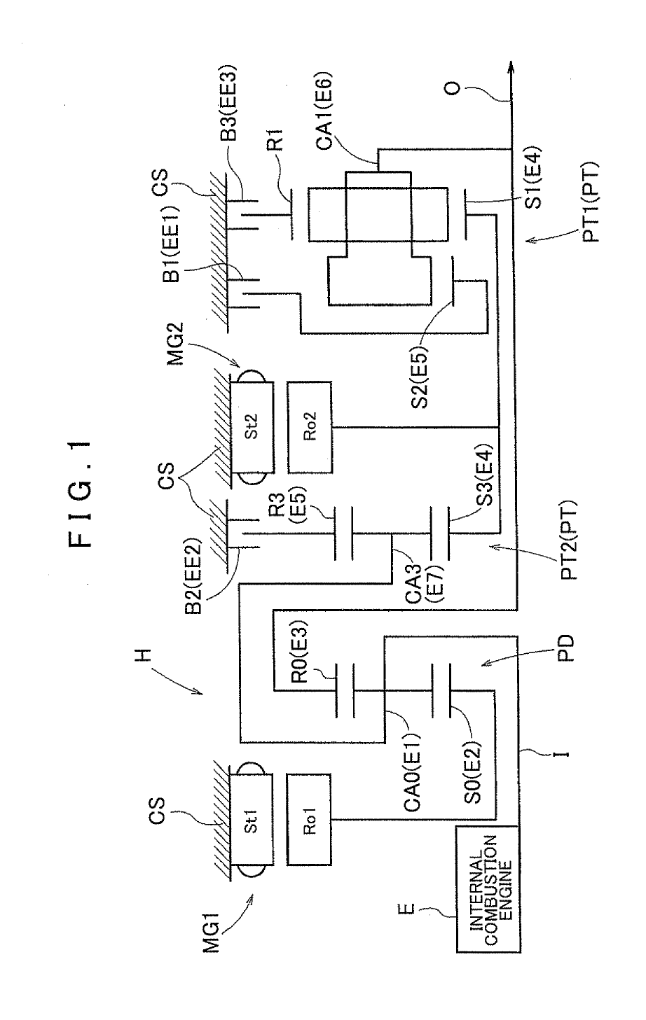

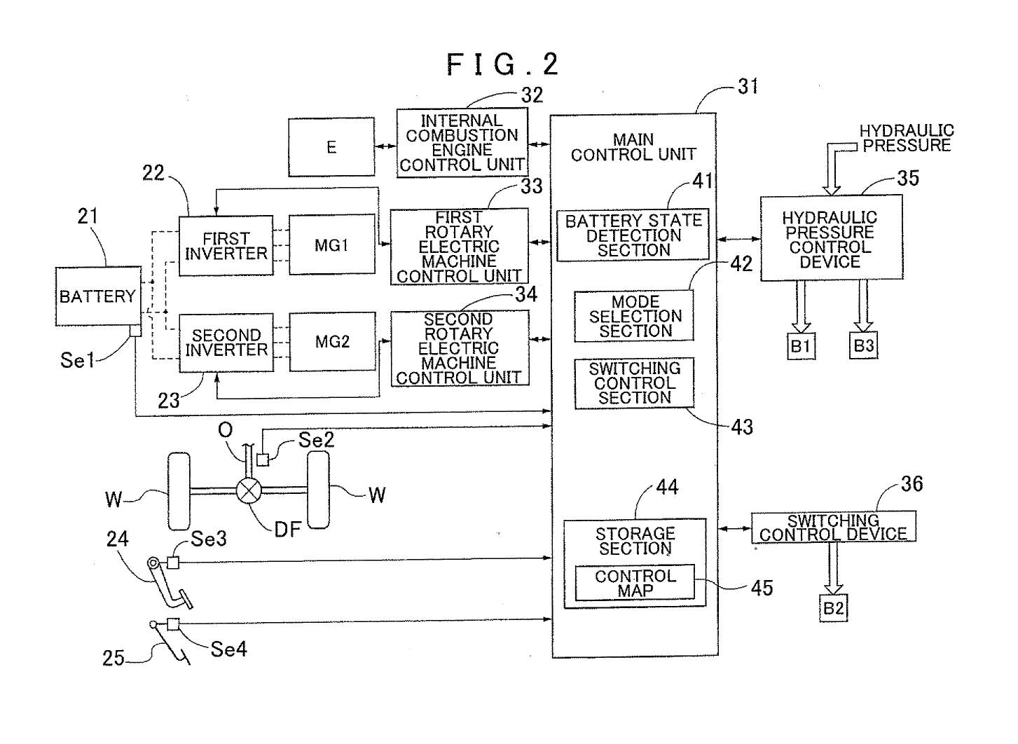

A hybrid drive device according to a first embodiment of the present invention will be described with reference to the drawings. FIG. 1 is a skeleton diagram showing the configuration of a hybrid drive device H according to the embodiment. In FIG. 1, an axially symmetric portion of the configuration is partly not shown. FIG. 2 is a schematic diagram showing the system configuration of the hybrid drive device H according to the embodiment. In FIG. 2, the solid arrows indicate transfer paths for various types of information, the broke lines indicate transfer paths for electric power, and the white arrows indicate transfer paths for a hydraulic pressure or power.

As shown in FIG. 1, the hybrid drive device H includes an input shaft I drivably coupled to an internal combustion engine E, an output shaft O drivably coupled to wheels W (see FIG. 2), a first rotary electric machine MG1, a second rotary electric machine MG2, a power distribution device PD including at least three rotary elements, and a transmission device PT including at least four rotary elements. These components are housed in a drive device case CS (hereinafter simply referred to as a “case CS”) serving as a non-rotary member fixed to a vehicle body. In the embodiment, the input shaft I corresponds to the “input member” according to the present invention, and the output shaft O corresponds to the “output member” according to the present invention.

1-1. Mechanical Configuration of Hybrid Drive Device

First, the mechanical configuration of various sections of the hybrid drive device H will be described. As shown in FIG. 1, the input shaft I is drivably coupled to the internal combustion engine E. The internal combustion engine E is a device driven by combusting fuel inside the engine to take out power. Various engines known in the art such as a gasoline engine and a diesel engine, for example, may be used as the internal combustion engine E. In the embodiment, the input shaft I is drivably coupled to an output rotary shaft, such as a crankshaft, of the internal combustion engine E to rotate together with the output rotary shaft. It is also suitable that the input shaft I is drivably coupled to the output rotary shaft of the internal combustion engine E via a damper, a clutch, a torque converter, or the like. Since the input shaft I rotates together with the output rotary shaft of the internal combustion engine E, rotational of the input shaft I is the same as rotational of the internal combustion engine E, and the drive force (including torque; the same applies hereinbelow) of the input shaft I is the same as the drive force of the internal combustion engine E.

As shown in FIG. 2, the output shaft O is drivably coupled to the wheels W (drive wheels) via an output differential gear device DF. The output shaft O is disposed coaxially with the input shaft I. Further, the entire hybrid drive device H has a single-axis configuration in which the internal combustion engine E, the first rotary electric machine MG1, the second rotary electric machine MG2, the power distribution device PD, and the transmission device PT are disposed coaxially with the input shaft I. Such a configuration is suitable as a configuration of the hybrid drive device H to be mounted on FR (Front-Engine Rear-Drive) vehicles, for example.

As shown in FIG. 1, the first rotary electric machine MG1 includes a stator S0 fixed to the case CS, and a rotor Ro1 supported on the radially inner side of the stator St1 so as to be freely rotatable. The rotor Ro1 of the first rotary electric machine MG1 is drivably coupled to a sun gear S0, serving as a reaction force rotary element E2 of the power distribution device PD, to rotate together with the sun gear S0. This allows the first rotary electric machine MG1 to function to receive a reaction force produced when the power distribution device PD distributes the drive force of the internal combustion engine E transferred via the input shaft I. The second rotary electric machine MG2 includes a stator St2 fixed to the case CS, and a rotor Ro2 supported on the radially inner side of the stator St2 so as to be freely rotatable. The rotor Ro2 of the second rotary electric machine MG2 is drivably coupled to a first sun gear S1, serving as a speed change input rotary element E4 of the transmission device PT, to rotate together with the first sun gear S1, and drivably coupled to a third sun gear S3, also serving as the speed change input rotary element E4 of the transmission device PT, to rotate together with the third sun gear S3. This allows the second rotary electric machine MG2 to be drivably coupled to a ring gear R0, serving as an output rotary element E3 of the power distribution device PD, or to a carrier CA0, serving as a distribution input rotary element E1 of the power distribution device PD, via the transmission device PT.

As shown in FIG. 2, the first rotary electric machine MG1 is electrically connected to a battery 21 via a first inverter 22. The second rotary electric machine MG2 is electrically connected to the battery 21 serving as an electricity accumulation device via a second inverter 23. Each of the first rotary electric machine MG1 and the second rotary electric machine MG2 can function both as a motor (electric motor) that is supplied with electric power to generate power and as a generator (electric generator) that is supplied with power to generate electric power. As discussed later, each of the first rotary electric machine MG1 and the second rotary electric machine MG2 functions as one of a generator and a motor in accordance with the relationship between the rotational direction and the direction of the drive force. When functioning as a generator, the first rotary electric machine MG1 or the second rotary electric machine MG2 supplies generated electric power to the battery 21 to charge the battery 21, or supplies generated electric power to the other rotary electric machine MG1 or MG2 functioning as a motor to cause the rotary electric machine to perform power running. When functioning as a motor, meanwhile, the first rotary electric machine MG1 or the second rotary electric machine MG2 is supplied with electric power charged in the battery 21 or generated by the other rotary electric machine MG1 or MG2 functioning as a generator to perform power running. Operation of the first rotary electric machine MG1 is controlled via a first rotary electric machine control unit 33 and the first inverter 22 in accordance with a control command from a main control unit 31. Operation of the second rotary electric machine MG2 is controlled via a second rotary electric machine control unit 34 and the second inverter 23 in accordance with a control command from the main control unit 31.

It is suitable that the battery 21 serving as an electricity accumulation device that supplies electric power to the first rotary electric machine MG1 and the second rotary electric machine MG2 is configured to be rechargeable by an external electric power source such as a household electric power source. In this case, although not shown, the battery 21 may be electrically connected to a connector connected to the external electric power source, or in the case where the external electric power source is an AC electric power source, an inverter that converts AC electric power into DC electric power or the like, in order to be charged by the external electric power source. It is also suitable that the battery 21 is not changed by an external electric power source but only charged by electric power generated by the first rotary electric machine MG1 or the second rotary electric machine MG2. The battery 21 is an exemplary electricity accumulation device. Other types of electricity accumulation devices such as a capacitor may be used, or a plurality of types electricity accumulation devices may be used in combination.

The power distribution device PD is a differential gear device including three rotary elements. In the embodiment, as shown in FIG. 1, the power distribution device PD is a single-pinion type planetary gear device disposed coaxially with the input shaft I. That is, the power distribution device PD includes, as its rotary elements, the carrier CA0 which supports a plurality of pinion gears, and the sun gear S0 and the ring gear R0 which each mesh with the pinion gears. The sun gear S0 is drivably coupled to the rotor Ro1 of the first rotary electric machine MG1 to rotate together with the rotor Ro1, and serves as the “reaction force rotary element E2” of the power distribution device PD. The carrier CA0 is drivably coupled to the input shaft I to rotate together with the input shaft I, and serves as the “distribution input rotary element E1” of the power distribution device PD. The ring gear R0 is drivably coupled to the output shaft O to rotate together with the output shaft O, and serves as the “output rotary element E3” of the power distribution device PD. The three rotary elements of the power distribution device PD form a sequence of the sun gear S0, the carrier CA0, and the ring gear R0 when arranged in the order of rotational speed. Thus, in the embodiment, the sun gear S0, the carrier CA0, and the ring gear R0 correspond to the “first rotary element”, the “second rotary element”, and the “third rotary element”, respectively, of the power distribution device PD.

The transmission device PT is a differential gear device including at least four rotary elements. In the embodiment, as shown in FIG. 1, the transmission device PT is formed by a combination of a first differential gear device PT1 including four rotary elements and a second differential gear device PT2 including three rotary elements.

The first differential gear device PT1 is a differential gear device including four rotary elements. In the embodiment, the first differential gear device PT1 is a Ravigneaux type planetary gear device including the first sun gear S1, a common carrier CA1, a common ring gear R1, and a second sun gear S2. In the embodiment, the common carrier CA1 supports a short pinion gear that meshes with both the first sun gear S1 and the common ring gear R1 and a stepped long pinion gear having a large diameter portion meshing with the second sun gear S2 and a small diameter portion meshing with the short pinion gear such that both the pinion gears are rotatable. The first sun gear S1 is drivably coupled to the third sun gear S3 of the second differential gear device PT2 to rotate together with the third sun gear S3, and drivably coupled to the rotor Ro2 of the second rotary electric machine MG2 to rotate together with the rotor Ro2. Thus, the first sun gear S1 of the first differential gear device PT1 and the third sun gear S3 of the second differential gear device PT2 serve as the “speed change input rotary element E4” of the transmission device PT. The common carrier CA1 is drivably coupled to the ring gear R0, serving as the output rotary element E3 of the power distribution device PD, to rotate together with the ring gear R0, and drivably coupled to the output shaft O to rotate together with the output shaft O. Thus, the common carrier CA1 serves as a “first output rotary element E6” of the transmission device PT. The common ring gear R1 is selectively fixed to the case CS serving as a non-rotary member through a third brake B3.

As discussed later, the common ring gear R1 is a rotary element that may be fixed through the third brake B3 to establish a third split mode, and does not serve as a fixed rotary element E5 of the transmission device PT according to the present invention. The second sun gear S2 is selectively fixed to the case CS serving as a non-rotary member through a first brake B1. The second sun gear S2 serves as the “fixed rotary element E5” of the transmission device PT when fixed through the first brake B1. The four rotary elements of the first differential gear device PT1 form a sequence of the second sun gear S2, the common ring gear R1, the common carrier CA1, and the first sun gear S1 when arranged in the order of rotational speed. Accordingly, in the embodiment, the second sun gear S2, the common ring gear R1, the common carrier CA1, and the first sun gear S1 correspond to the “first rotary element” the “second rotary element”, the “third rotary element”, and the “fourth rotary element”, respectively, of the first differential gear device PT1.

The second differential gear device PT2 is a differential gear device including three rotary elements. In the embodiment, the second differential gear device PT2 is a single-pinion type planetary gear device. That is, the second differential gear device PT2 includes, as its rotary elements, a third carrier CA3 that supports a plurality of pinion gears, and the third sun gear S3 and a third ring gear R3 that each mesh with the pinion gears. As described above, the third sun gear S3 is drivably coupled to the first sun gear S1 of the first differential gear device PT1 to rotate together with the first sun gear S1, and drivably coupled to the rotor Ro2 of the second rotary electric machine MG2 to rotate together with the rotor Ro2. The third sun gear S3 serves as the speed change input rotary element E4 of the transmission device PT. The third carrier CA3 is drivably coupled to the carrier CA0, serving as the distribution input rotary element E1 of the power distribution device PD, to rotate together with the carrier CA0, and drivably coupled to the input shaft I. Thus, the third carrier CA3 serves as a “second output rotary element E7” of the transmission device PT. The third ring gear R3 is selectively fixed to the case CS serving as a non-rotary member via a second brake B2. Thus, the third ring gear R3 serves as the “fixed rotary element E5” of the transmission device PT when fixed through the second brake B2. The three rotary elements of the second differential gear device PT2 form a sequence of the third ring gear R3, the third carrier CA3, and the third sun gear S3 when arranged in the order of rotational speed. Accordingly, in the embodiment, the third ring gear R3, the third carrier CA3, and the third sun gear S3 correspond to the “first rotary element”, the “second rotary element”, and the “third rotary element”, respectively, of the second differential gear device PT2.

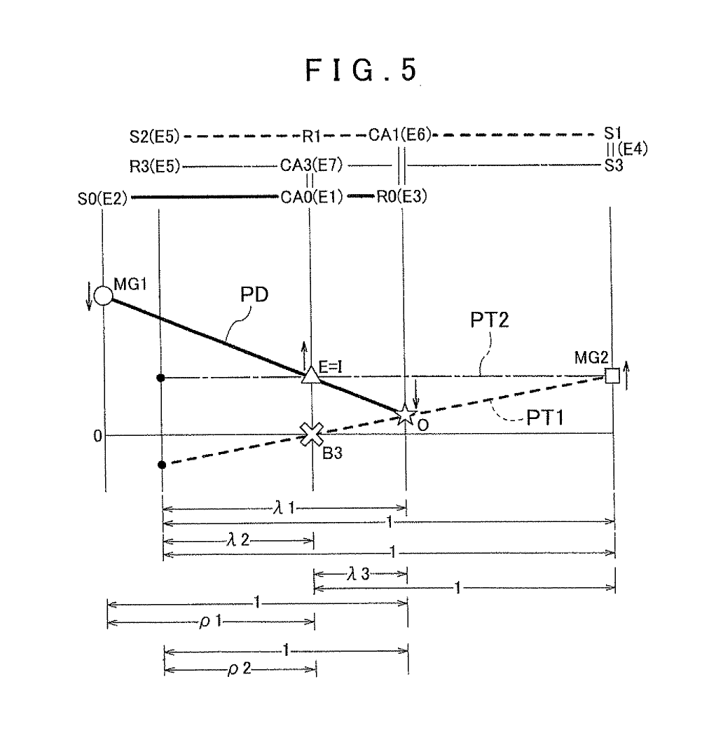

In the transmission device PT, as described above, one (in the embodiment, the first sun gear S1) of the rotary elements of the first differential gear device PT, which includes four rotary elements, and one (in the embodiment, the third sun gear S3) of the rotary elements of the second differential gear device PT2, which includes three rotary elements, are drivably coupled to each other to rotate together. Thus, the transmission device PT according to the embodiment is a differential gear device including six rotary elements as a whole. As shown in the upper portion of the velocity diagrams of FIGS. 5 to 7, of the six rotary elements of the transmission device PT, five rotary elements excluding the common ring gear R1 form a sequence of the first sun gear S1 and the third sun gear S3 which rotate together with each other, the common carrier CA1, the third carrier CA3, and the second sun gear S2 and the third ring gear R3 which rotate independently of each other, when arranged in the order of rotational speed. In other words, the five rotary elements of the transmission device PT form a sequence of the speed change input rotary element E4, the first output rotary element E6, the second output rotary element E7, and the two fixed rotary elements E5 (which is the same as a sequence of the fixed rotary elements E5, the second output rotary element E7, the first output rotary element E6, and the speed change input rotary element E4) when arranged in the order of rotational speed.

The first brake B1 selectively fixes the second sun gear S2 of the first differential gear device PT1, serving as one of the two fixed rotary elements E5 provided in the transmission device PT, to the case CS serving as a non-rotary member. When the first brake B1 is in the engaged state, rotation of the second rotary electric machine MG2, which is drivably coupled to the first sun gear S1 serving as the speed change input rotary element E4, is reduced in speed by the first differential gear device PT1, and transferred to the output shaft O via the common carrier CA1 serving as the first output rotary element E6. In the embodiment, the first brake B1 forms a “first engagement device EE1” according to the present invention. As discussed later, a first split mode is established by bringing the first brake B1 to the engaged state. Accordingly, in the embodiment, the first brake B1 serving as the first engagement device EE1 functions as a “first split mode engagement device” according to the present invention.

The second brake B2 selectively fixes the third ring gear R3 of the second differential gear device PT2, serving as the other of the two fixed rotary elements E5 provided in the transmission device PT, to the case CS serving as a non-rotary member. When the second brake B2 is in the engaged state, rotation of the second rotary electric machine MG2, which is drivably coupled to the third sun gear S3 serving as the speed change input rotary element E4, is reduced in speed by the second differential gear device PT2, and transferred to the carrier CA0 serving as the distribution input rotary element E1 via the third carrier CA3 serving as the second output rotary element E7. In the embodiment, the second brake B2 forms a “second engagement device EE2” according to the present invention. As discussed later, a second split mode is established by bringing the second brake B2 to the engaged state. Therefore, the second brake B2 serving as the second engagement device EE2 functions as a “second split mode engagement device” according to the present invention.

The third brake B3 selectively fixes the common ring gear R1 of the first differential gear device PT1 to the case CS serving as a non-rotary member. When the third brake B3 is in the engaged state, rotation of the second rotary electric machine MG2, which is drivably coupled to the first sun gear S1 serving as the speed change input rotary element E4, is reduced in speed by the first differential gear device PT1, and transferred to the output shaft O via the common carrier CA1 serving as the first output rotary element E6. The common ring gear R1 is set, in the order of rotational speed, between the second sun gear S2 serving as the fixed rotary element E5 fixed through the first brake B1 and the common carrier CA1 serving as the first output rotary element E6 drivably coupled to the output shaft O. Thus, rotation transferred from the second rotary electric machine MG2 to the output shaft O when the third brake B3 is in the engaged state is reduced in speed significantly (at a high speed reduction ratio) compared to when the first brake B1 is in the engaged state. In the embodiment, as shown in FIGS. 5 to 7, the common ring gear R1 is set at the same position as the carrier CA0 of the power distribution device PD and the third carrier CA3 of the second differential gear device PT2 on the velocity diagrams. However, the common ring gear R1 may be set at a position different from the carrier CA0 and the third carrier CA3. In the embodiment, the third brake B3 forms a “third engagement device EE3” according to the present invention. As discussed later, the third split mode is established by bringing the third brake B3 to the engaged state. Therefore, the third brake B3 functions as a “third split mode engagement device”.

In the embodiment, the first brake B1 and the third brake B3 are each a friction engagement device. As each of the engagement devices B1 and B3, a multi-plate friction brake that operates on a hydraulic pressure, for example, may be used. As shown in FIG. 2, a hydraulic pressure control device 35 that operates in accordance with a control command from the main control unit 31 supplies a hydraulic pressure to the engagement devices B1 and 133 to control engagement and disengagement of the brakes B1 and B3 using the hydraulic pressure. A hydraulic pressure generated by an oil pump (not shown) is supplied to the hydraulic pressure control device 35.

In the embodiment, on the other hand, the second brake B2 serving as the second engagement device EE2 which is the second split mode engagement device is a mechanical two-way engagement device. In the two-way engagement device, as known in the art, two engagement members are provided so as to be rotatable relative to each other, for example, and one of the two engagement members is formed with a cam surface that faces the other member, and a torque transfer member such as a roller is disposed in a space formed between the cam surface and the other member. The position at which the torque transfer member is held in the above space can be changed by a predetermined drive unit (in the embodiment, a switching control device 36 to be discussed next). This allows the two-way engagement device to switchably include at least two states including a state in which rotation of one of the engagement members provided in the two-way engagement device relative to the other engagement member is allowed in two directions, namely a positive direction and a negative direction, and a state in which such rotation is allowed in only one of the positive direction and the negative direction and restricted in the other. In the embodiment, the second brake B2 is provided between the case CS serving as a non-rotary member and the third ring gear R3 serving as the fixed rotary element E5. The second brake B2 is capable of switching rotation of the third ring gear R3 serving as the fixed rotary element E5 relative to the case CS between a two-way allowing state in which such rotation of the third ring gear R3 is allowed in both directions and a positive-direction restricting state in which the rotation is allowed only in the negative direction and restricted in the positive direction. That is, in the two-way allowing state, the second brake B2 completely disengages the third ring gear R3 so that the third ring gear R3 is rotatable in both directions, namely the positive direction and the negative direction. In the positive-direction restricting state, meanwhile, the second brake B2 functions as a one-way clutch (one-way brake) that allows rotation of the third ring gear R3 only in the negative direction, and is brought to the engaged state to fix the third ring gear R3 to the case CS when the third ring gear R3 is urged to rotate in the positive direction.

In the embodiment, the hybrid drive device H includes the switching control device 36 (see FIG. 2) that switches the state of the second brake B2, in other words, that changes the position at which the torque transfer member is held in the above space in the two-way engagement device to switch between the two-way allowing state and the positive-direction restricting state. In the embodiment, an electromagnetic actuator such as a linear motor is used as the switching control device 36. Alternatively, a hydraulic actuator that utilizes a hydraulic pressure generated by an electric oil pump or the like may be used to form the switching control device 36. Since the second brake B2 is formed by a two-way engagement device as described above, it is only necessary to actuate the switching control device 36 when switching is performed between the respective states that the second brake B2 may take. Thus, it is no longer necessary to continuously generate a hydraulic pressure or the like in order to maintain the engaged state, unlike a case where the second brake B2 is also formed by a friction engagement device or the like, for example. Accordingly, the energy efficiency of the entire hybrid drive device H can be improved by using a two-way engagement device as the second brake B2 serving as the second engagement device EE2. In the embodiment, further, since the second brake B2 is formed by a two-way engagement device, mode switching can be performed quickly. This will be discussed later.

The hybrid drive device H according to the embodiment is formed on the basis of an existing hybrid drive device which includes only the first differential gear device PT1 as the transmission device PT and in which rotation of the second rotary electric machine MG2 is transferred to the output shaft O via the transmission device PT, and formed by adding the second differential gear device PT2 and the second brake B2 to such an existing hybrid drive device to establish the second split mode. This is one of the factors considered to adopt a configuration in which the two-way engagement device described above is used as the second brake B2 serving as the second engagement device EE2. That is, with such a configuration, it is not necessary to additionally provide an oil passage for supplying a hydraulic pressure to the second brake B2, and therefore changes to be made to the case CS and so forth can be advantageously minimized.

1-2. Configuration of Control System of Hybrid Drive Device

As shown in FIG. 2, the hybrid drive device H includes the main control unit 31 that controls various sections of the device. The main control unit 31 is connected to an internal combustion engine control unit 32, the first rotary electric machine control unit 33, the second rotary electric machine control unit 34, the hydraulic pressure control device 35, and the switching control device 36 to enable transfer of information between each other. The internal combustion engine control unit 32 controls various sections of the internal combustion engine E such that the internal combustion engine E achieves a desired rotational speed and a desired drive force (torque). The first rotary electric machine control unit 33 controls the first inverter 22 such that the first rotary electric machine MG1 achieves a desired rotational speed and a desired drive force (torque). The second rotary electric machine control unit 34 controls the second inverter 23 such that the second rotary electric machine MG2 achieves a desired rotational speed and a desired drive force (torque). The hydraulic pressure control device 35 adjusts a hydraulic pressure supplied from an oil pump (not shown) and distributes the hydraulic pressure to the brakes B1 and B3 to control the states (engagement and disengagement) of the brakes B1 and B3. The switching control device 36 causes an electromagnetic actuator to output power as necessary to control the state (the two-way allowing state and the positive-direction restricting state) of the second brake B2. The states of the brakes B1, B2, and B3 are controlled on the basis of a control command from the main control unit 31.

In addition, the main control unit 31 is configured to acquire information from sensors or the like provided at various sections of the vehicle incorporating the hybrid drive device H in order to acquire information on the various sections of the vehicle. In the illustrated example, the main control unit 31 is configured to acquire information from a battery state detection sensor Se1, a vehicle speed sensor Se2, an accelerator pedal operation detection sensor Se3, and a brake pedal operation detection sensor Se4. The battery state detection sensor Se1 is a sensor that detects the state of the battery 21 such as a charge amount, and may be formed by a voltage sensor, a current sensor, or the like, for example. The vehicle speed sensor Se2 is a sensor that detects the rotational speed of the output shaft O in order to detect the vehicle speed. The accelerator pedal operation detection sensor Se3 is a sensor that detects the operation amount of an accelerator pedal 24. The brake pedal operation detection sensor Se4 is a sensor that detects the operation amount of a brake pedal 25 that operates in conjunction with wheel brakes (not shown).

The main control unit 31 uses the information acquired from the sensors Se1 to Se4 to select among a plurality of operation modes to be discussed later. Then, the main control unit 31 performs mode switching (switches between operation modes) by controlling the states of the brakes B1 and B3 via the hydraulic pressure control device 35 and controlling the state of the second brake B2 via the switching control device 36. In addition, the main control unit 31 cooperatively controls the operating states of the internal combustion engine E, the first rotary electric machine MG1, and the second rotary electric machine MG2 via the internal combustion engine control unit 32, the first rotary electric machine control unit 33, and the second rotary electric machine control unit 34 so as to run the vehicle appropriately in accordance with the selected operation mode. In the embodiment, in particular, the first rotary electric machine control unit 33 and the second rotary electric machine control unit 34 cooperatively control the operating states of the first rotary electric machine MG1 and the second rotary electric machine MG2, respectively, so as to maintain a state in which electric power consumed by one of the first rotary electric machine MG1 and the second rotary electric machine MG2 for power running and electric power generated by the other of the first rotary electric machine MG1 and the second rotary electric machine MG2 are balanced with each other.

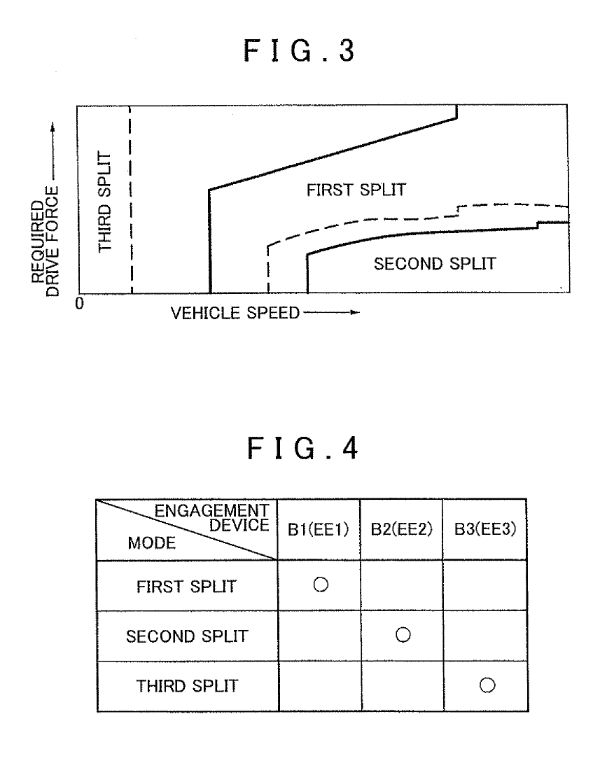

Therefore, in the embodiment, the main control unit 31 includes a battery state detection section 41, a mode selection section 42, and a switching control section 43 as functional sections that execute various types of control. Each unit provided in the main control unit 31 includes an arithmetic processing unit such as a CPU serving as its core member, and a functional unit formed by hardware, software (a program), or a combination of both to perform various processes on input data. The main control unit 31 also includes a storage section 44 that stores a control map 45 (see FIG. 3) for use to determine the operation mode in accordance with the vehicle speed and the required drive force.

The battery state detection section 41 detects, through estimation, the state of the battery 21 such as a charge amount on the basis of information output from the battery state detection sensor Se1 such as a voltage value or a current value. The battery charge amount is generally called an SOC (state of charge), and may be obtained as the ratio of the remaining charge amount to the charge capacity of the battery 21, for example.

The mode selection section 42 selects an appropriate operation mode in accordance with the states of various sections of the vehicle using a predetermined control map. In the embodiment, the mode selection section 42 selects one of a plurality of modes, specifically the first split mode, the second split mode, and the third split mode, as a hybrid operation mode in accordance with the vehicle speed and the required drive force using the control map 45 shown in FIG. 3. As shown in FIG. 3, the control map 45 according to the embodiment is defined by a plurality of mode switching lines, which roughly define a relationship that the vehicle speed is constant irrespective of the magnitude of the required drive force when the required drive force is relatively small, and that the vehicle speed becomes higher as the required drive force becomes larger when the required drive force is relatively large. In the hybrid drive device H according to the embodiment, as shown in FIG. 3, basically, the third split mode, the first split mode, and the second split mode are selected in this order as the vehicle speed rises. In the embodiment, hysteresis is provided in mode switching between the respective modes as discussed later. In FIG. 3, the solid lines are mode switching lines used when the vehicle speed rises, and the broken lines are mode switching lines used when the vehicle speed is lowered.

The switching control section 43 individually engages and disengages the first brake B1 and the third brake B3 by controlling operation of the hydraulic pressure control device 35 in accordance with the operation mode selected by the mode selection section 42. The switching control section 43 switches the state of the second brake B2 between the two-way allowing state and the positive-direction restricting state by controlling operation of the switching control device 36 in accordance with the operation mode selected by the mode selection section 42. This allows the switching control section 43 to perform control so as to switch between the operation modes of the hybrid drive device H.

1-3. Operation Modes of Hybrid Drive Device

Next, the running modes that can be established by the hybrid drive device H according to the embodiment will be described. FIG. 4 is an operation table showing the operating states of the first brake B1 (first engagement device EE1), the second brake B2 (second engagement device EE2), and the third brake B3 (third engagement device EE3) in each operation mode. In the drawing, the symbol “∘” indicates that each engagement device is in the engaged state (for the second brake B2, in the positive-direction restricting state), and the presence of no symbol” indicates that each engagement device is in the disengaged state (for the second brake B2, in the two-way allowing state).

FIGS. 5 to 7 are each a velocity diagram showing the operating states of the power distribution device PD, the first differential gear device PT1, and the second differential gear device PT2 in each operation mode. In the velocity diagrams, the vertical axis corresponds to the rotational speed of each rotary element. That is, the indication “0” provided on the vertical axis indicates that the rotational speed is zero, with the upper side corresponding to positive rotation (the rotational speed is positive) and the lower side corresponding to negative rotation (the rotational speed is negative). A plurality of vertical lines disposed in parallel with each other correspond to the rotary elements of the power distribution device PD, the first differential gear device PT1, and the second differential gear device PT2. The indications “S0”, “CA0”, and “R0” provided above the vertical lines correspond to the sun gear S0, the carrier CA0, and the ring gear R0, respectively, of the power distribution device PD. The indications “S1”, “CA1”, “R1”, and “S2” correspond to the first sun gear S1, the common carrier CA1, the common ring gear R1, and the second sun gear S2, respectively, of the first differential gear device PT1. The indications “S3”, “CA3”, and “R3” correspond to the third sun gear S3, the third carrier CA3, and the third ring gear R3, respectively, of the second differential gear device PT2. The symbol “=” connecting the indications of rotary elements provided above the vertical lines indicates a state in which the plurality of rotary elements are drivably coupled to each other to rotate together.

The intervals between the vertical lines corresponding to the rotary elements are determined on the basis of the number of teeth of each rotary element provided in the planetary gear mechanism forming the power distribution device PD, the number of teeth of each rotary element provided in the Ravigneaux type planetary gear device forming part (first differential gear device PT1) of the transmission device PT, and the number of teeth of each rotary element provided in the planetary gear mechanism forming other part (second differential gear device PT2) of the transmission device PT. An additional description will be made using the planetary gear mechanism forming the power distribution device PD as an example. The ratio of the interval between the vertical line corresponding to the carrier CA0 and the vertical line corresponding to the ring gear R0 to the interval between the vertical line corresponding to the sun gear S0 and the vertical line corresponding to the carrier CA0 matches the ratio of the number of teeth of the sun gear S0 to the number of teeth of the ring gear R0 of the power distribution device PD. Also for the transmission device PT, the intervals between the vertical lines corresponding to predetermined rotary elements are determined in accordance with the ratio between the numbers of teeth of the rotary elements, although not described in detail here.

In the embodiment, the relationship between the numbers of teeth of the rotary elements provided in the power distribution device PD and the transmission device PT (the first differential gear device PT1 and the second differential gear device PT2) is set such that a first relative rotational speed ratio ρ1 and a second relative rotational speed ratio ρ2 are different from each other. The first relative rotational speed ratio ρ1 is the ratio of the relative rotational speed of the carrier CA0 serving as the distribution input rotary element E1 to the relative rotational speed of the ring gear R0 serving as the output rotary element E3, which is determined on the basis of the rotational speed of the sun gear S0 of the power distribution device PD serving as the reaction force rotary element E2. Accordingly, in FIGS. 5 to 7, the ratio of the interval between the vertical line corresponding to the sun gear S0 and the vertical line corresponding to the carrier CA0 to the interval between the vertical line corresponding to the sun gear S0 and the vertical line corresponding to the ring gear R0 is equal to the first relative rotational speed ratio ρ2. The second relative rotational speed ratio ρ2 is the ratio of the relative rotational speed of the third carrier CA3 of the second differential gear device PT2 serving as the second output rotary element E7 to the relative rotational speed of the common carrier CA1 of the first differential gear device PT1 serving as the first output rotary element E6, which is determined on the basis of the rotational speed of the second sun gear S2 of the first differential gear device PT1 or the third ring gear R3 of the second differential gear device PT2, serving as the fixed rotary element E5. Accordingly, in FIGS. 5 to 7, the ratio of the interval between the vertical line corresponding to the second sun gear S2 and the third ring gear R3 and the vertical line corresponding to the third carrier CA3 to the interval between the vertical line corresponding to the second sun gear S2 and the third ring gear R3 and the vertical line corresponding to the common carrier CA1 is equal to the second relative rotational speed ratio ρ2.

In the embodiment, the common carrier CA1, serving as the first output rotary element E6 of the first differential gear device PT1, is drivably coupled to the ring gear R0, serving as the output rotary element E3 of the power distribution device PD, to rotate together with the ring gear R0. In addition, the third carrier CA3, serving as the second output rotary element E7 of the second differential gear device PT2, is drivably coupled to the carrier CA0, serving as the distribution input rotary element E1 of the power distribution device PD, to rotate together with the carrier CA0. Accordingly, with the first relative rotational speed ratio ρ1 and the second relative rotational speed ratio ρ2 set in the hybrid drive device H according to the embodiment, the relative rotational speed of the sun gear S0 serving as the reaction force rotary element E2 and the relative rotational speed of the second sun gear S2 and the third ring gear R3 serving as the fixed rotary elements E5, which is determined on the basis of the rotational speed of the ring gear R0 serving as the output rotary element E3 and the common carrier CA1 serving as the first output rotary element E6, or the rotational speed of the carrier CA0 serving as the distribution input rotary element E1 and the third carrier CA3 serving as the second output rotary element E7, are different from each other. Therefore, as shown in FIGS. 5 to 7, in the velocity diagrams indicating the operating states of the power distribution device PD, the first differential gear device PT1, and the second differential gear device PT2, the vertical line corresponding to the sun gear S0 serving as the reaction force rotary element E2 and the vertical line corresponding to the second sun gear S2 and the third ring gear R3 serving as the fixed rotary elements E5 are provided at different positions.

In the embodiment, further, the first relative rotational speed ratio ρ1 is set to be higher than the second relative rotational speed ratio ρ2. Thus, in the velocity diagrams indicating the operating states of the power distribution device PD, the first differential gear device PT1, and the second differential gear device PT2, the vertical line corresponding to the sun gear S0 serving as the reaction force rotary element E2 is provided opposite the vertical line corresponding to the ring gear R0 serving as the output rotary element E3 and the common carrier CA1 serving as the first output rotary element E6 and the vertical line corresponding to the carrier CA0 serving as the distribution input rotary element E1 and the third carrier CA3 serving as the second output rotary element E7 with respect to the vertical line corresponding to the second sun gear S2 and the third ring gear R3, serving as the fixed rotary elements E5.

In the drawings, the symbol “x” indicates a state in which the rotary element is fixed to the case CS serving as a non-rotary member, and the symbol “x” accompanied by an indication “B1”, “B2”, or “B3” indicates a state in which the rotary element is fixed through the first brake B1, the second brake B2, or the third brake B3. In the case where the rotary element is fixed through the second brake B2, the second brake B2 is brought to the positive-direction restricting state to function as a one-way clutch. In the velocity diagrams, in addition, the symbol “Δ” indicates the rotational speed of the input shaft I (internal combustion engine E), the symbol “∘” indicates the rotational speed of the first rotary electric machine MG1, the symbol “□” indicates the rotational speed of the second rotary electric machine MG2, and the symbol “⋆” indicates the rotational speed of the output shaft O. Further, the arrow provided adjacent to a symbol indicating the rotational speed of a corresponding rotary element indicates the direction of torque applied to the rotary element during normal running in each operation mode, and the arrow pointing up indicates torque in the positive direction and the arrow pointing down indicates torque in the negative direction. The operating state of the hybrid drive device H in each of the plurality of operation modes will be described in detail below.

1-3-1. Third Split Mode

The third split mode is an operation mode selected in the lowest vehicle speed range of the three split modes (see FIG. 3). In the third split mode, the drive force of the internal combustion engine E is distributed by the power distribution device PD and transferred to the output shaft O, and rotation of the second rotary electric machine MG2 is reduced in speed by the transmission device PT, and the drive force of the second rotary electric machine MG2 is transferred to the ring gear R0 serving as the output rotary element E3 and the output shaft O. In the third split mode, in addition, the first rotary electric machine MG1 generates a reaction force, which causes the drive force of the internal combustion engine E (input shaft I) to be transferred to the output shaft O via the power distribution device PD. Meanwhile, the second rotary electric machine MG2 operates to compensate for a shortage of the drive force from the internal combustion engine E. Operations of the various sections in the third split mode are similar to those in the first split mode to be discussed later, except that the speed change ratio (speed reduction ratio) at which rotation of the second rotary electric machine MG2 is transferred to the output shaft O is higher than that in the first split mode.

As shown in FIG. 4, the third split mode is established with the third brake B3 in the engaged state and the first brake B1 and the second brake B2 in the disengage state (for the second brake B2, in the two-way allowing state). FIG. 5 is a velocity diagram for the third split mode. The drive force transferred from the internal combustion engine E to the carrier CA0 of the power distribution device PD via the input shaft I is distributed by the power distribution device PD and transferred to the output shaft O. At this time, the first rotary electric machine MG1 operates to receive a reaction force.

In the third split mode, by bringing the second brake B2 to the two-way allowing state, the third ring gear R3 is made to be freely rotatable. This makes the second differential gear device PT2 of the transmission device PT substantially inoperable. By bringing the first brake B1 to the disengaged state, in addition, the second sun gear S2 of the first differential gear device PT1 is also made to be freely rotatable. By bringing the third brake B3 to the engaged state, moreover, the common ring gear R1 of the first differential gear device PT1 is fixed to the case CS. This allows rotation and the drive force of the first sun gear S1, which serves as the speed change input rotary element E4 of the transmission device PT and which rotates together with the rotor Ro2 of the second rotary electric machine MG2, to be reduced in speed by the first differential gear device PT1 and transferred to the common carrier CA1 serving as the first output rotary element E6 of the transmission device PT. Since the common carrier CA1 is drivably coupled to the ring gear R0, serving as the output rotary element E3 of the power distribution device PD, and the output shaft O to rotate together with the ring gear R0 and the output shaft O, rotation and the drive force of the second rotary electric machine MG2 which have been reduced in speed are transferred to the output shaft O via the common carrier CA1. Specifically, in the third split mode, as shown in the lower portion of the velocity diagram of FIG. 5, rotation of the second rotary electric machine MG2 is reduced in speed at a rate of “λ3” (λ3<λ1<1) and transferred to the output shaft O. At this time, the speed reduction ratio is “1/λ3”. Accordingly, torque of the second rotary electric machine MG2 is amplified at a rate of “1/λ3” and transferred to the output shaft O. Herein, rotation reduced in speed relative to rotation of the first sun gear S1 serving as the speed change input rotary element E4 and transferred to the output shaft O via the common carrier CA1 serving as the first output rotary element E6 in the third split mode is referred to as “third reduced rotation”. The third reduced rotation has been reduced in speed at a speed change ratio (speed reduction ratio) higher than that for first reduced rotation in the first split mode to be discussed later, and therefore the third reduced rotation is lower in speed than the first reduced rotation for the same rotation of the speed change input rotary element E4.

With the thus configured third split mode, in a split mode in which rotation of the second rotary electric machine MG2 is transferred to the output shaft O via the common carrier CA1 serving as the first output rotary element E6, torque of the second rotary electric machine MG2 can be amplified compared to that in the first split mode to be discussed later and transferred to the output shaft O. Accordingly, the vehicle can be driven with a larger drive force, or the size of the second rotary electric machine MG2 can be reduced while securing the same drive force.

In the third split mode, the first rotary electric machine MG1 is controlled so as to achieve a rotational speed and torque that are appropriate for the internal combustion engine E to be driven with a suitable fuel efficiency in accordance with the vehicle speed, the required drive force, and so forth. That is, the power distribution device PD distributes the drive force of the internal combustion engine E to the output shaft O and the first rotary electric machine MG1 in the state where the internal combustion engine E is driven with a suitable fuel efficiency. In this state, the first rotary electric machine MG1 generates electric power by outputting torque in the negative direction while rotating in the positive direction. The second rotary electric machine MG2 basically consumes the exact amount of electric power generated by the first rotary electric machine MG1 to perform power running by outputting torque in the positive direction while rotating in the positive direction.

1-3-2. First Split Mode

The first split mode is an operation mode selected in the middle vehicle speed range of the three split modes (see FIG. 3). In the first split mode, the drive force of the internal combustion engine E is distributed by the power distribution device PD and transferred to the output shaft O, and rotation of the second rotary electric machine MG2 is reduced in speed by the transmission device PT, and the drive force of the second rotary electric machine MG2 is transferred to the ring gear R0 serving as the output rotary element E3 and the output shaft O. In the first split mode, in addition, the first rotary electric machine MG1 generates a reaction force, which causes the drive force of the internal combustion engine E (input shaft I) to be transferred to the output shaft O via the power distribution device PD. Meanwhile, the second rotary electric machine MG2 operates to compensate for a shortage of the drive force from the internal combustion engine E. Operations of the various sections in the first split mode are similar to those in the third split mode discussed above, except that the speed change ratio (speed reduction ratio) at which rotation of the second rotary electric machine MG2 is transferred to the output shaft O is lower than that in the third split mode.

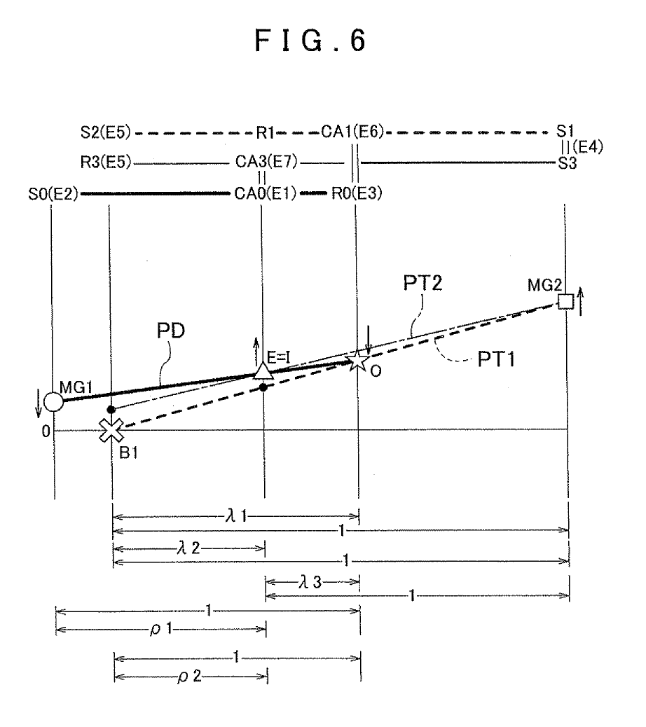

As shown in FIG. 4, the first split mode is established with the first brake B1 in the engaged state and the second brake B2 and the third brake B3 in the disengage state (for the second brake B2, in the two-way allowing state). FIG. 6 is a velocity diagram for the first split mode. The drive force transferred from the internal combustion engine E to the carrier CA0 of the power distribution device PD via the input shaft I is distributed by the power distribution device PD and transferred to the output shaft O. At this time, the first rotary electric machine MG1 operates to receive a reaction force.

In the first split mode, by bringing the second brake B2 to the two-way allowing state, the third ring gear R3 is made to be freely rotatable. This makes the second differential gear device PT2 of the transmission device PT substantially inoperable. By bringing the third brake B3 to the disengaged state, in addition, the common ring gear R1 of the first differential gear device PT1 is also made to be freely rotatable. By bringing the first brake B1 to the engaged state, moreover, the second sun gear S2 of the first differential gear device PT1 is fixed to the case CS. This allows rotation and the drive force of the first sun gear S1, which serves as the speed change input rotary element E4 of the transmission device PT and which rotates together with the rotor Ro2 of the second rotary electric machine MG2, to be reduced in speed by the first differential gear device PT1 and transferred to the common carrier CA1 serving as the first output rotary element E6 of the transmission device PT. Since the common carrier CA1 is drivably coupled to the ring gear R0, serving as the output rotary element E3 of the power distribution device PD, and the output shaft O to rotate together with the ring gear R0 and the output shaft O, rotation and the drive force of the second rotary electric machine MG2 which have been reduced in speed are transferred to the output shaft O via the common carrier CA1. Specifically, in the first split mode, as shown in the lower portion of the velocity diagram of FIG. 6, rotation of the second rotary electric machine MG2 is reduced in speed at a rate of “λ1” (λ3<λ1<1) and transferred to the output shaft O. At this time, the speed reduction ratio is “1/λ1”. Accordingly, torque of the second rotary electric machine MG2 is amplified at a rate of “1/λ1” and transferred to the output shaft O. Herein, rotation reduced in speed relative to rotation of the first sun gear S1 serving as the speed change input rotary element E4 and transferred to the output shaft O via the common carrier CA1 serving as the first output rotary element E6 in the first split mode is referred to as the “first reduced rotation”. The first reduced rotation is a rotation that has been reduced in speed at a speed change ratio (speed reduction ratio) lower than that for the third reduced rotation discussed above and second reduced rotation to be discussed later, and therefore the first reduced rotation is higher in speed than the third reduced rotation and the second reduced rotation for the same rotation of the speed change input rotary element E4.

In the first split mode, the first rotary electric machine MG1 is controlled so as to achieve a rotational speed and torque that are appropriate for the internal combustion engine E to be driven with a suitable fuel efficiency in accordance with the vehicle speed, the required drive force, and so forth. That is, the power distribution device PD distributes the drive force of the internal combustion engine E to the output shaft O and the first rotary electric machine MG1 in the state where the internal combustion engine E is driven with a suitable fuel efficiency. In this state, the first rotary electric machine MG1 generates electric power by outputting torque in the negative direction while rotating in the positive direction. The second rotary electric machine MG2 basically consumes the exact amount of electric power generated by the first rotary electric machine MG1 to perform power running by outputting torque in the positive direction while rotating in the positive direction. When the vehicle speed rises in this state, the rotational speed of the first rotary electric machine MG1 is lowered, reaches zero, and becomes negative in the course of time along with a rise in rotational speed of the output shaft O. In this state, the first rotary electric machine MG1 performs power running by outputting torque in the negative direction while rotating in the negative direction. The second rotary electric machine MG2 basically generates electric power by outputting torque in the negative direction while rotating in the positive direction in order to supply the first rotary electric machine MG1 with the exact amount of electric power required by the first rotary electric machine MG1 to perform power running.

1-3-3. Second Split Mode

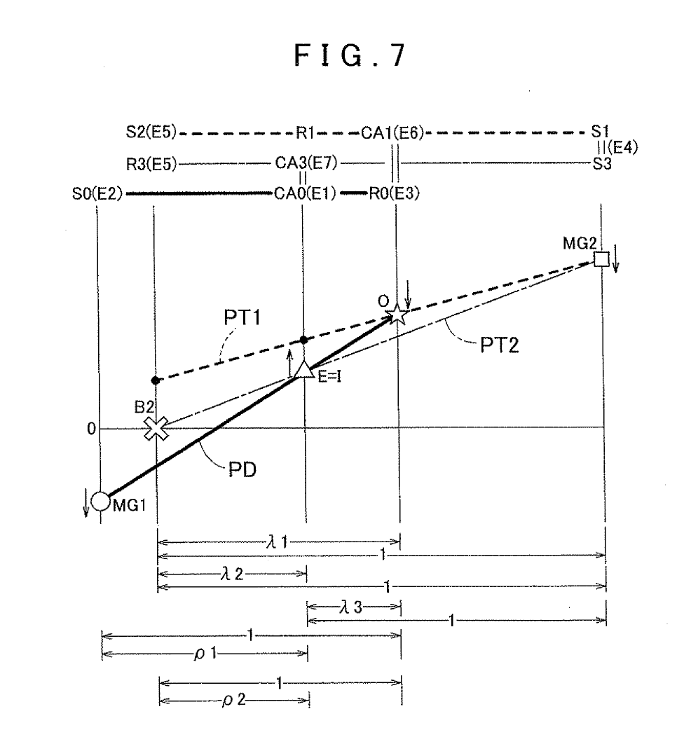

The second split mode is an operation mode selected in the highest vehicle speed range of the three split modes (see FIG. 3). In the second split mode, the drive force of the internal combustion engine E is distributed by the power distribution device PD and transferred to the output shaft O, and rotation of the second rotary electric machine MG2 is reduced in speed by the transmission device PT, and the drive force of the second rotary electric machine MG2 is transferred to the carrier CA0 serving as the distribution input rotary element E1. In the second split mode, in addition, the first rotary electric machine MG1 generates a reaction force, which causes the drive force of the internal combustion engine E (input shaft I) to be transferred to the output shaft O via the power distribution device PD. The second split mode is selected in a region where the rotational speed of the output shaft O is increased and the rotational speed of the first rotary electric machine MG1 becomes negative as shown in FIG. 7. At this time, the first rotary electric machine MG1 performs power running by outputting torque in the negative direction while rotating in the negative direction, and the second rotary electric machine MG2 generates electric power by outputting torque in the negative direction while rotating in the positive direction, as in the case where the rotational speed of the first rotary electric machine MG1 becomes negative in the first split mode.

As shown in FIG. 4, the second split mode is established with the second brake B2 in the engaged state (positive-direction restricting state) and the first brake B1 and the third brake B3 in the disengage state. FIG. 7 is a velocity diagram for the second split mode. In the second split mode, the vehicle speed is high, and the running torque is relatively low. As in the first split mode and the third split mode, the drive force transferred from the internal combustion engine E to the carrier CA0 of the power distribution device PD via the input shaft I is distributed by the power distribution device PD and transferred to the output shaft O. At this time, the first rotary electric machine MG1 operates to receive a reaction force.

In the second split mode, by bringing the first brake B1 and the third brake B3 to the disengaged state, the second sun gear S2 and the common ring gear R1 of the first differential gear device PT1 are made to be freely rotatable. This makes the first differential gear device PT1 of the transmission device PT substantially inoperable. In the second split mode, as described above, the second rotary electric machine MG2 outputs torque in the negative direction. Thus, the rotational speed of the third sun gear S3 drivably coupled to the rotor Ro2 of the second rotary electric machine MG2 is urged to vary in the negative direction, and the rotational speed of the third ring gear R3 is urged to vary in the positive direction using the third carrier CA3 drivably coupled to the input shaft I as a fulcrum. At this time, the second brake B2 is in the positive-direction restricting state. Thus, when the rotational speed of the third ring gear R3 rises to become zero in the course of time, the second brake B2 is brought to the engaged state, which fixes the third ring gear R3 to the case CS serving as a non-rotary member. This allows rotation and the drive force of the third sun gear S3, which serves as the speed change input rotary element E4 and which rotates together with the rotor Ro2 of the second rotary electric machine MG2, to be reduced in speed by the second differential gear device PT2 and transferred to the third carrier CA3 serving as the second output rotary element E7 of the transmission device PT. Since the third carrier CA3 is drivably coupled to the carrier CA0 serving as the distribution input rotary element E1, and the input shaft I to rotate together with the carrier CA0 and the input shaft I, rotation and the drive force of the second rotary electric machine MG2 which have been reduced in speed are transferred to the carrier CA0 of the power distribution device PD and the input shaft I via the third carrier CA3. Specifically, in the second split mode, as shown in the lower portion of the velocity diagram of FIG. 7, rotation of the second rotary electric machine MG2 is reduced in speed at a rate of “λ2” (λ2<λ1<1) and transferred to the carrier CA0 of the power distribution device PD. At this time, the speed reduction ratio is “1/λ2”. Accordingly, torque of the second rotary electric machine MG2 is amplified at a rate of “1/λ2” and transferred to the carrier CA0 of the power distribution device PD. Herein, rotation reduced in speed relative to rotation of the third sun gear S3 serving as the speed change input rotary element E4 and transferred to the carrier CA0 serving as the distribution input rotary element E1 via the third carrier CA3 serving as the second output rotary element E7 in the second split mode is referred to as the “second reduced rotation”. The second reduced rotation has been reduced in speed at a speed change ratio (speed reduction ratio) higher than that for the first reduced rotation, and therefore the second reduced rotation is lower in speed than the first reduced rotation for the same rotation of the speed change input rotary element E4.

In the second split mode, the first rotary electric machine MG1 is controlled so as to achieve a rotational speed and torque that are appropriate for the internal combustion engine E to be driven a suitable fuel efficiency in accordance with the vehicle speed, the required drive force, and so forth. That is, the first rotary electric machine MG1 performs power running such that the internal combustion engine E is driven with a suitable fuel efficiency. In this state, the first rotary electric machine MG1 operates to receive a reaction force. On the other hand, the drive force from the internal combustion engine E is increased in speed by the second differential gear device PT2 of the transmission device PT and transferred to the second rotary electric machine MG2. In this state, the second rotary electric machine MG2 generates electric power. That is, in the second split mode, the second rotary electric machine MG2 is rotated by the drive force transferred from the internal combustion engine E (input shaft I), and generates electric power by outputting torque in the negative direction while rotating in the positive direction. In this state, due to operation of the power distribution device PD and the second differential gear device PT2 of the transmission device PT, the drive force generated from the internal combustion engine E is distributed and transferred to the second rotary electric machine MG2 and the output shaft O. At this time, the second differential gear device PT2 of the transmission device PT operates as a speed increase device from a viewpoint of the power distribution device PD, and as a speed reduction device from a viewpoint of the second rotary electric machine MG2.

The hybrid drive device H according to the embodiment switchably includes the second split mode, and thus can suppress occurrence of power circulation when the vehicle is running at a high speed. That is, in a region where the rotational speed of the output shaft O is increased and the rotational speed of the first rotary electric machine MG1 becomes negative along with a rise in vehicle speed, the first rotary electric machine MG1 performs power running, and the second rotary electric machine MG2 generates electric power. In this event, if the second split mode is selected, the drive force of the internal combustion engine E is directly transferred to the second rotary electric machine MG2. Thus, it is possible to prevent the drive force generated by the power running of the first rotary electric machine MG1 from being used for the electric power generation performed by the second rotary electric machine MG2, and to prevent the electric power generated by the second rotary electric machine MG2 from being utilized for the power running performed by the first rotary electric machine MG1 again. Occurrence of power circulation can thus be suppressed. In this event, in addition, rotation from the second rotary electric machine MG2 which has been reduced in speed is directly transferred to the carrier CA0, serving as the distribution input rotary element E1 of the power distribution device PD, not via the output shaft O. Accordingly, part of the drive force of the internal combustion engine E is offset by torque of the second rotary electric machine MG2. Therefore, in the second split mode, torque to be output by the first rotary electric machine MG1 in order to receive a reaction force against the drive force of the internal combustion engine E can be reduced compared a state in which rotation and the drive force of the second rotary electric machine MG2 are directly transferred to the output shaft O as in the first split mode. Thus, only a small proportion of the drive force of the internal combustion engine E is converted into electric power, which improves the energy efficiency of the hybrid drive device H.

1-4. Switching between Operation Modes

Next, mode switching between the running modes will be described. In the embodiment, basically, mode switching between the first split mode and the second split mode is performed by switching the engagement states of the first brake B1 and the second brake B2, and mode switching between the first split mode and the third split mode is performed by switching the engagement states of the first brake B1 and the third brake B3 (see FIG. 4). The two types of mode switching will be described below in order.

1-4-1. Mode Switching between First Split Mode and Second Split Mode

Mode switching from the first split mode to the second split mode is performed by disengaging the first brake B1 and engaging the second brake B2. In the embodiment, mode switching from the first split mode to the second split mode is performed at a “rotation synchronization point” at which the rotational speeds of engagement members on both sides of the second brake B2, serving as a second split mode engagement device that is to be engaged in such mode switching, become equal to each other. In the embodiment, as described above, the second brake B2 is an engagement device that selectively fixes the third ring gear R3 of the second differential gear device PT2 to the case CS serving as a non-rotary member. Accordingly, in the embodiment, an operating point at which the rotational speed of the third ring gear R3 of the second differential gear device PT2 becomes zero is defined as the rotation synchronization point, and mode switching is performed at the rotation synchronization point. Mode switching from the first split mode to the second split mode is basically performed when the vehicle speed rises.

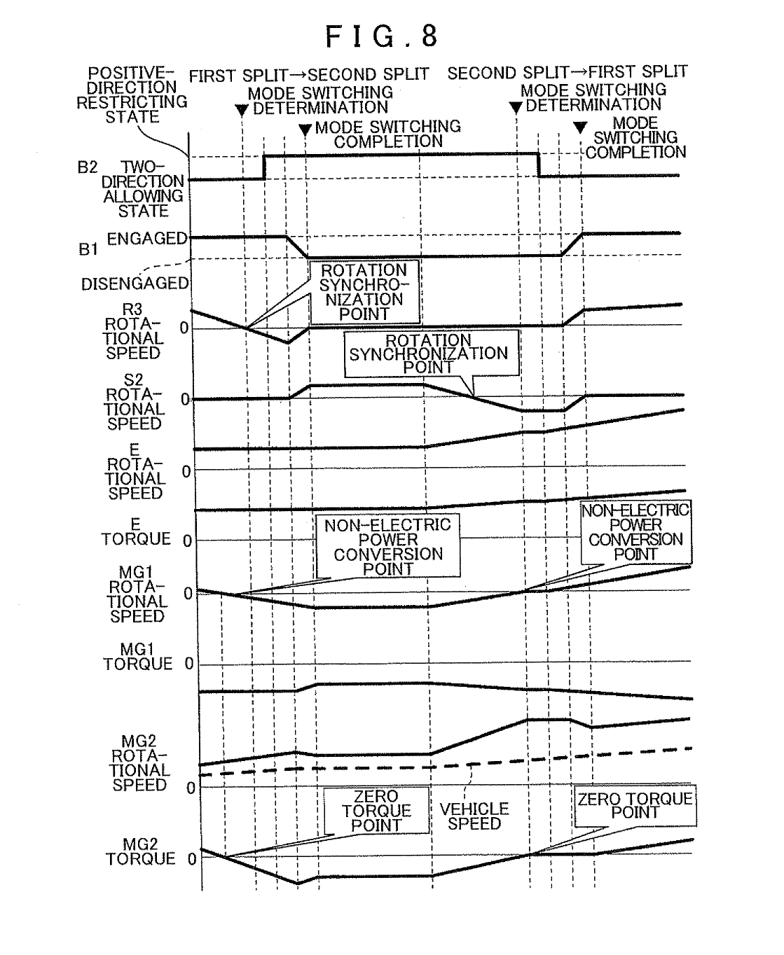

FIG. 8 is a time chart showing the process of mode switching between the first split mode and the second split mode according to the embodiment. The left half of the time chart of FIG. 8 shows the process of mode switching from the first split mode to the second split mode. In the embodiment, the operating point of the internal combustion engine E is controlled such that the internal combustion engine E is maintained in an operating state with a suitable fuel efficiency. In the first split mode, the first rotary electric machine MG1 generates electric power by outputting torque in the negative direction while rotating in the positive direction, and the second rotary electric machine MG2 performs power running by outputting torque in the positive direction while rotating in the positive direction. When the rotational speed of the output shaft O rises along with a rise in vehicle speed, for example, the rotational speed of the first rotary electric machine MG1 is gradually lowered with the first rotary electric machine MG1 rotating in the positive direction via the power distribution device PD, and becomes zero in the course of time. The operating point at which the rotational speed of the first rotary electric machine MG1 becomes zero is defined as a “non-electric power conversion point” at which work achieved by the drive force of the internal combustion engine E is not converted into electric power (no electric power conversion is performed). In the embodiment, mode switching from the first split mode to the second split mode is not yet performed at the non-electric power conversion point.

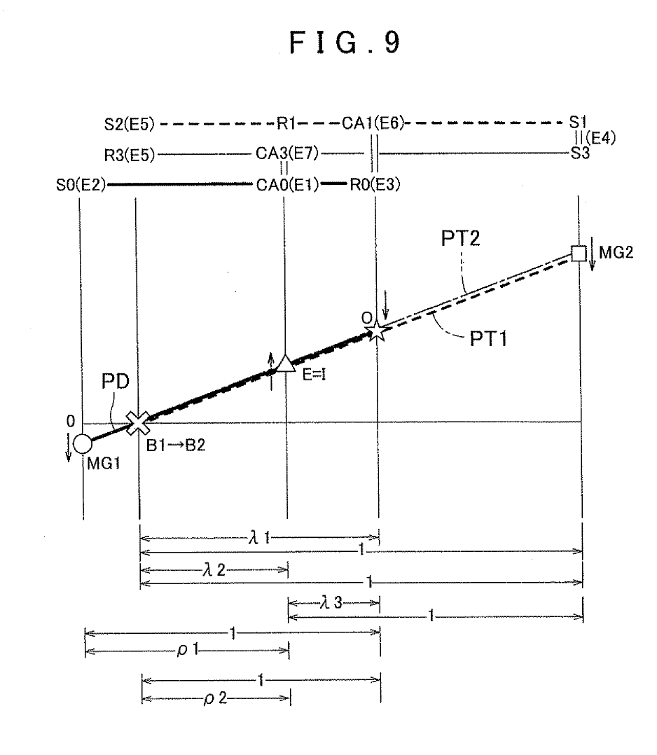

When the vehicle speed further rises and the rotational speed of the output shaft O further rises, the rotational speed of the first rotary electric machine MG1 is gradually lowered with the first rotary electric machine MG1 rotating in the negative direction. At this time, the first rotary electric machine MG1 performs power running by outputting torque in the negative direction while rotating in the negative direction. On the other hand, the second rotary electric machine MG2 generates electric power by outputting torque in the negative direction while rotating in the positive direction. Along with a rise in rotational speed of the output shaft O, in addition, the rotational speed of the second rotary electric machine MG2 gradually rises with the second rotary electric machine MG2 rotating in the positive direction via the first differential gear device PT1. When the rotational speed of the second rotary electric machine MG2 rises, the rotational speed of the third ring gear R3 is gradually lowered with the third ring gear R3 rotating in the positive direction via the second differential gear device PT2. In the course of time, mode switching from the first split mode to the second split mode is performed at the rotation synchronization point at which the rotational speed of the third ring gear R3 becomes zero (see FIG. 9).

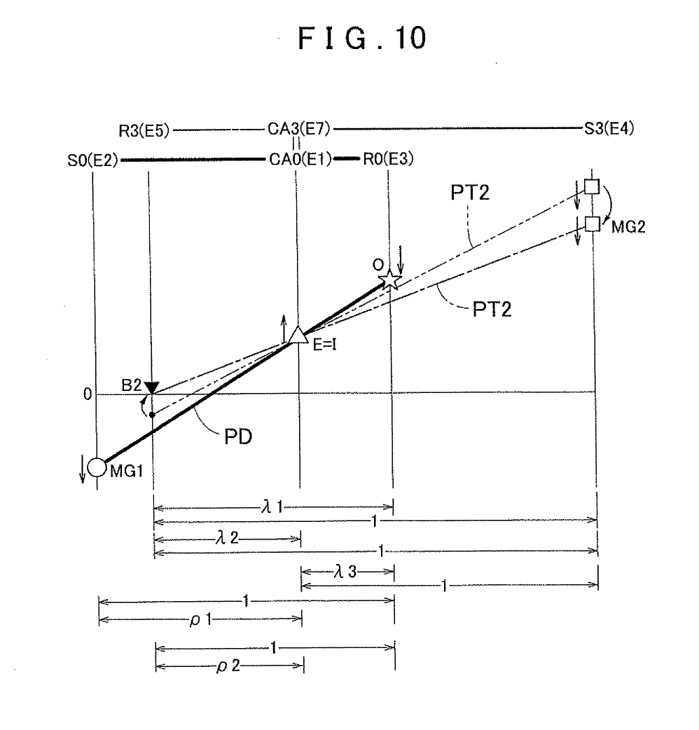

To be more exact, a determination as to mode switching from the first split mode to the second split mode is made at the rotation synchronization point at which the rotational speed of the third ring gear R3 becomes zero. In the embodiment, even after the mode switching determination is made, the rotational speed of the first rotary electric machine MG1 is further lowered, along with which the rotational speed of the third ring gear R3 is further lowered. In this state, the switching control device 36 switches the state of the second brake B2, which is formed by a two-way engagement device in the embodiment, from the two-way allowing state to the positive-direction restricting state. Thereafter, the first brake B1 serving as the first split mode engagement device is disengaged through hydraulic pressure control performed via the hydraulic pressure control device 35. Then, as shown in FIG. 10, the second rotary electric machine MG2 is outputting torque in the negative direction. Thus, the rotational speed of the second rotary electric machine MG2 is lowered, and the rotational speed of the third ring gear R3 of the second differential gear device PT2 serving as the fixed rotary element E5 varies in the positive direction to rise using the third carrier CA3, which is drivably coupled to the input shaft I to rotate together with the input shaft I, as a fulcrum. Then, when the rotational speed of the third ring gear R3 rises to become zero, the second brake B2 is brought to the engaged state to forcibly restrict the rotational speed of the third ring gear R3 to zero so that the third ring gear R3 of the second differential gear device PT2, which is one of the two fixed rotary elements E5, is fixed to the case CS through the second brake B2. Mode switching from the first split mode to the second split mode is thus completed. In the second split mode, occurrence of power circulation can be suppressed as discussed above, and the energy efficiency of the hybrid drive device H can be improved.

In FIG. 10 showing the process of mode switching from the first split mode to the second split mode, the second brake B2 which has been brought to the positive-direction restricting state is indicated by a black inverted triangle. Although not shown in FIG. 10 in consideration of viewability, as the rotational speed of the second rotary electric machine MG2 is lowered by disengagement of the first brake B1, the rotational speed of the second sun gear S2 of the first differential gear device PT1 varies in the positive direction to rise using the common carrier CA1, which is drivably coupled to the output shaft O to rotate together with the output shaft O, as a fulcrum (see FIG. 8).

Thus, in the embodiment, mode switching from the first split mode to the second split mode is performed by switching the second brake B2 from the two-way allowing state to the positive-direction restricting state with the third ring gear R3, which serves as the fixed rotary element E5, rotating in the negative direction. In this way, mode switching can be performed quickly utilizing torque of the second rotary electric machine MG2 in the negative direction for electric power generation without controlling the rotational speed of the second rotary electric machine MG2 so as to converge the rotational speed of the third ring gear R3 to zero. In addition, it is not necessary to perform mode switching with the transmission device brought to the neutral state as in the related art, and occurrence of a drive force interruption during mode switching can be suppressed. Moreover, the directions of torque of both the first rotary electric machine MG1 and the second rotary electric machine MG2 are not changed before and after mode switching. Thus, no variations in torque are transferred to the output shaft O, and occurrence of a shock during mode switching can be suppressed. Furthermore, mode switching can be performed without particularly varying the operating point of the internal combustion engine E. Thus, the internal combustion engine E is maintained in an operating state with a suitable fuel efficiency, which does not deteriorate the fuel consumption rate.

On the other hand, mode switching from the second split mode to the first split mode is performed by disengaging the second brake B2 and engaging the first brake B1. In the embodiment, mode switching from the second split mode to the first split mode is performed at a “non-electric power conversion point” at which the rotational speed of the first rotary electric machine MG1 becomes zero and no electric power conversion is performed. In the embodiment, as described above, the first rotary electric machine MG1 and the second rotary electric machine MG2 are controlled so as to maintain a state in which electric power consumed by one of the first rotary electric machine MG1 and the second rotary electric machine MG2 for power running and electric power generated by the other of the first rotary electric machine MG1 and the second rotary electric machine MG2 are balanced with each other. Accordingly, in the embodiment, such a non-electric power conversion point is also an operating point at which torque of the second rotary electric machine MG2 becomes zero. Thus, in the embodiment, the non-electric power conversion point corresponds to a “zero torque point” according to the present invention. Mode switching from the second split mode to the first split mode is basically performed when the vehicle speed is lowered or the required drive force rises.

The right half of the time chart of FIG. 8 described earlier shows the process of mode switching from the second split mode to the first split mode. In the embodiment, the operating point of the internal combustion engine E is controlled such that the internal combustion engine E is maintained in an operating state with a suitable fuel efficiency. In the embodiment, although not shown in the drawing, mode switching from the second split mode to the first split mode is performed when the depression amount of the accelerator pedal 24 (see FIG. 2) is increased by the driver of the vehicle and the required drive force is increased accordingly. In the second split mode, the first rotary electric machine MG1 performs power running by outputting torque in the negative direction while rotating in the negative direction, and the second rotary electric machine MG2 generates electric power by outputting torque in the negative direction while rotating in the positive direction. In this state, when the internal combustion engine E outputs a larger drive force and the rotational speed of the internal combustion engine E rises in order to accelerate the vehicle, the rotational speed of the second rotary electric machine MG2 gradually rises with the second rotary electric machine MG2 rotating in the positive direction via the second differential gear device PT2. When the rotational speed of the second rotary electric machine MG2 rises, the rotational speed of the second sun gear S2 is gradually lowered with the second sun gear S2 rotating in the positive direction via the first differential gear device PT1. In the course of time, a “rotation synchronization point” at which the rotational speed of the second sun gear S2 becomes zero is reached. In the embodiment, mode switching from the second split mode to the first split mode is not yet performed at the rotation synchronization point.

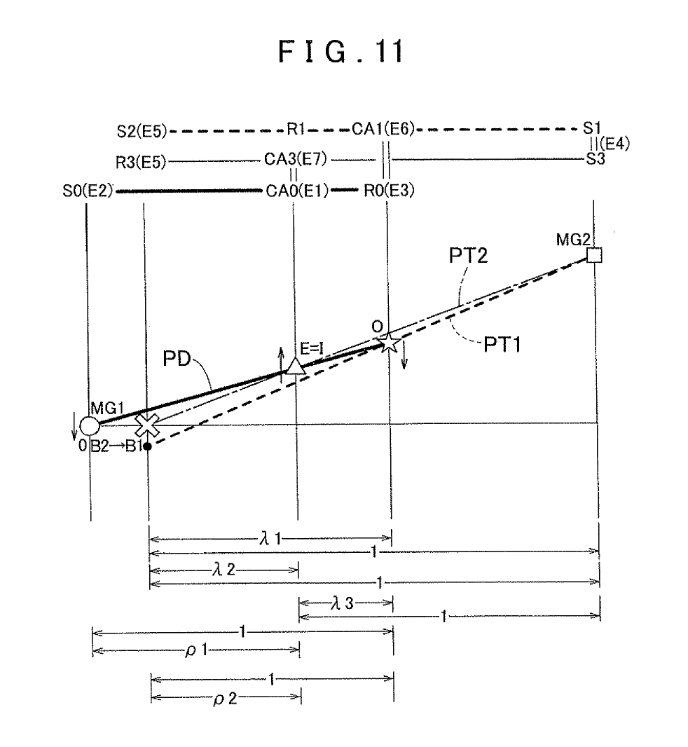

Along with a rise in rotational speed of the internal combustion engine E, in addition, the rotational speed of the first rotary electric machine MG1 gradually rises with the first rotary electric machine MG1 rotating in the negative direction via the power distribution device PD. Then, after the above rotation synchronization point is passed, the rotational speed of the first rotary electric machine MG1 becomes zero in the course of time (see FIG. 11). The operating point at which the rotational speed of the first rotary electric machine MG1 becomes zero is defined as a “non-electric power conversion point” at which work achieved by the drive force of the internal combustion engine E is not converted into electric power (no electric power conversion is performed). In the embodiment, mode switching from the second split mode to the first split mode is performed at the non-electric power conversion point.

To be more exact, a determination as to mode switching from the second split mode to the first split mode is made at the non-electric power conversion point at which the rotational speed of the first rotary electric machine MG1 becomes zero. In the embodiment, after the mode switching determination is made, the rotational speed of the first rotary electric machine MG1 is maintained at zero for a predetermined period of time. At the same time as the rotational speed of the first rotary electric machine MG1 becomes zero, torque of the second rotary electric machine MG2 also becomes zero, and is maintained at zero for a predetermined period of time thereafter. In this state, the switching control device 36 switches the state of the second brake B2, which is formed by a two-way engagement device in the embodiment, from the positive-direction restricting state to the two-way allowing state. Thereafter, the first brake B1 serving as the first split mode engagement device is engaged through hydraulic pressure control performed via the hydraulic pressure control device 35. Then, the second sun gear S2 of the first differential gear device PT1, which is one of the two fixed rotary elements E5, is fixed to the case CS through the first brake B1. Mode switching from the second split mode to the first split mode is thus completed.

At this time, the rotational speed of the second rotary electric machine MG2 varies in the negative direction using the common carrier CA1, which is drivably coupled to the output shaft O to rotate together with the output shaft O, as a fulcrum, and is thus lowered. As the rotational speed of the second rotary electric machine MG2 is lowered, the rotational speed of the third ring gear R3 of the second differential gear device PT2 varies in the positive direction to rise using the third carrier CA3, which is drivably coupled to the input shaft I to rotate together with the input shaft I, as a fulcrum. After mode switching to the first split mode, the first rotary electric machine MG1 generates electric power by outputting torque in the negative direction while rotating in the positive direction. Thus, the direction of torque of the second rotary electric machine MG2 becomes positive, and the second rotary electric machine MG2 performs power running by outputting torque in the positive direction while rotating in the positive direction.

In the embodiment, as described above, mode switching from the second split mode to the first split mode is performed with the rotational speed of the first rotary electric machine MG1 being zero, that is, with the second rotary electric machine MG2 outputting no torque (zero torque). In this way, no variations in torque of the second rotary electric machine MG2 are transferred to the output shaft O, and occurrence of a shock during mode switching can be suppressed. Furthermore, mode switching can be performed without particularly varying the operating point of the internal combustion engine E. Thus, the internal combustion engine E is maintained in an operating state with a suitable fuel efficiency, which does not deteriorate the fuel consumption rate.

In the embodiment, as has been described above, the relationship between the numbers of teeth of the predetermined rotary elements of the power distribution device PD and the transmission device PT is set such that the first relative rotational speed ratio ρ1 is higher than the second relative rotational speed ratio ρ2. Therefore, mode switching between the first split mode and the second split mode can be performed at a selected one of two switching points, namely the rotation synchronization point and the non-electric power conversion point (zero torque point). In the embodiment, mode switching from the first split mode to the second split mode is performed at the rotation synchronization point, which is one of the two switching points, and mode switching from the second split mode to the first split mode is performed at the non-electric power conversion point (zero torque point), which is the other of the two switching points. That is, mode switching from the first split mode to the second split mode is performed at the rotation synchronization point after the non-electric power conversion point (zero torque point) is passed, and mode switching from the second split mode to the first split mode is performed at the non-electric power conversion point (zero torque point) after the rotation synchronization point is passed. In the embodiment, by setting the switching points as described above, hysteresis is provided in mode switching between the first split mode and the second split mode (see FIG. 3). Accordingly, it is possible to prevent mode switching from being performed frequently in a short period of time, and to avoid giving the driver of the vehicle a sense of busyness due to such mode switching.

1-4-2. Mode Switching between First Split Mode and Third Split Mode

Mode switching from the first split mode to the third split mode is performed by disengaging the first brake B1 and engaging the third brake B3. That is, when predetermined mode switching conditions are met, the first brake B1 is disengaged and the third brake B3 is engaged through hydraulic pressure control performed via the hydraulic pressure control device 35, and in cooperation with this, the rotational speed of the second rotary electric machine MG2 is controlled so as to lower the rotational speed of the common ring gear R1 of the first differential gear device PT1 to converge to zero. When the rotational speed of the common ring gear R1 becomes zero, the third brake B3 is completely engaged through hydraulic pressure control performed via the hydraulic pressure control device 35. Mode switching from the first split mode to the third split mode is thus completed. The rotational speed of the common ring gear R1 may be converged to zero through only any one of rotational speed control for the second rotary electric machine MG2 and hydraulic pressure control for the first brake B1 and the third brake B3.

On the other hand, mode switching from the third split mode to the first split mode is performed by disengaging the third brake B3 and engaging the first brake B1. That is, when predetermined mode switching conditions are met, the third brake B3 is disengaged and the first brake B1 is engaged through hydraulic pressure control performed via the hydraulic pressure control device 35, in cooperation with which the rotational speed of the second rotary electric machine MG2 is controlled so as to raise the rotational speed of the second sun gear S2 of the first differential gear device PT1 to converge to zero. When the rotational speed of the second sun gear S2 becomes zero, the first brake B1 is completely engaged through hydraulic pressure control performed via the hydraulic pressure control device 35. Mode switching from the third split mode to the first split mode is thus completed. The rotational speed of the second sun gear S2 may be converged to zero through only any one of rotational speed control for the second rotary electric machine MG2 and hydraulic pressure control for the first brake B1 and the third brake B3.

2. Second Embodiment

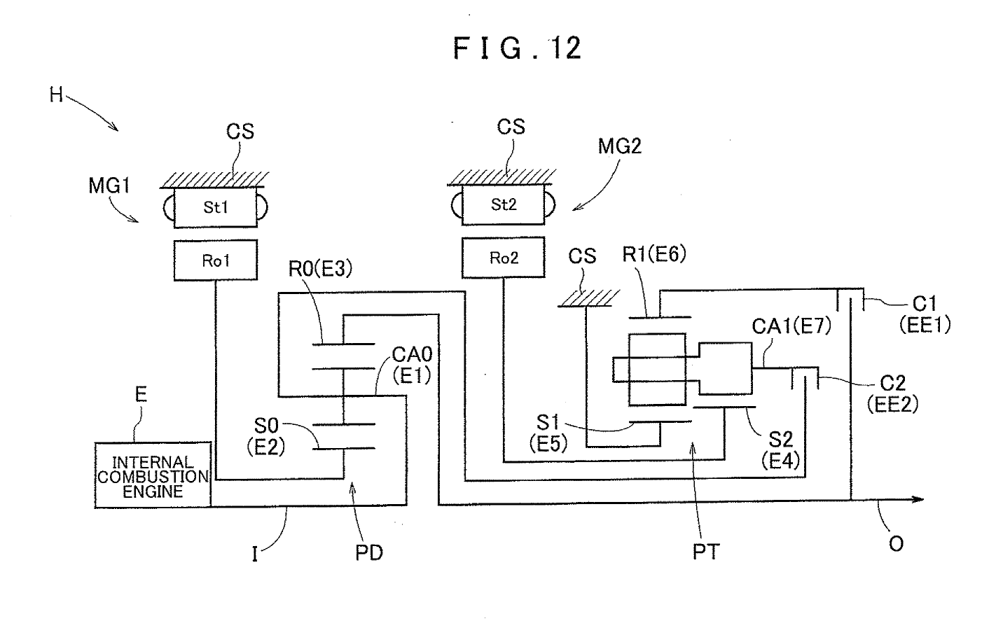

A hybrid drive device according to a second embodiment of the present invention will be described with reference to the drawings. FIG. 12 is a skeleton diagram showing the configuration of a hybrid drive device H according to the embodiment. In FIG. 12, as in FIG. 1, an axially symmetric portion of the configuration is partly not shown. The hybrid drive device H according to the embodiment can establish a fewer number of operation modes than that according to the above first embodiment. That is, the hybrid drive device H can establish only two operation modes, namely the first split mode and the second split mode, and the third split mode described in the above first embodiment is omitted. Along with the omission of the third split mode, only two engagement devices are provided, and the configuration of the transmission device PT is changed. Differences between the hybrid drive device H according to the embodiment and that according to the above first embodiment will be mainly described below. The same elements as those in the above first embodiment will not be specifically described.

2-1. Mechanical Configuration of Hybrid Drive Device

Also in the embodiment, the configuration of the power distribution device PD is the same as that in the above first embodiment. On the other hand, the configuration of the transmission device PT is different from that in the above first embodiment. In the embodiment, as shown in FIG. 12, the transmission device PT is formed by a differential gear device including four rotary elements.

The transmission device PT is a differential gear device including four rotary elements. In the embodiment, the transmission device PT is a Ravigneaux type planetary gear device including four rotary elements, namely a first sun gear S1, a common carrier CA1, a common ring gear R1, and a second sun gear S2. That is, the transmission device PT according to the embodiment is formed only by a differential gear device having the same configuration as that of the first differential gear device PT1 forming part of the transmission device PT according to the above first embodiment. Accordingly, also in the embodiment, the common carrier CA1 supports a short pinion gear that meshes with both the first sun gear S1 and the common ring gear R1 and a stepped long pinion gear having a large diameter portion meshing with the second sun gear S2 and a small diameter portion meshing with the short pinion gear such that both the pinion gears are rotatable. The first sun gear S1 is always fixed to the case CS serving as a non-rotary member. Thus, the first sun gear S1 serves as the “fixed rotary element E5” of the transmission device PT. The second sun gear S2 is drivably coupled to the rotor Ro2 of the second rotary electric machine MG2 to rotate together with the rotor Ro2. Thus, the second sun gear S2 serves as the “speed change input rotary element E4” of the transmission device PT. The common carrier CA1 is selectively drivably coupled to the carrier CA0 of the power distribution device PD serving as the distribution input rotary element E1 via a second clutch C2 serving as the second engagement device EE2. Thus, the common carrier CA1 serves as the “second output rotary element E7” of the transmission device PT. The common ring gear R1 is selectively drivably coupled to the output shaft O and the ring gear R0 of the power distribution device PD serving as the output rotary element E3 via a first clutch C1 serving as the first engagement device EE1. Thus, the common ring gear R1 serves as the “first output rotary element E6” of the transmission device PT.

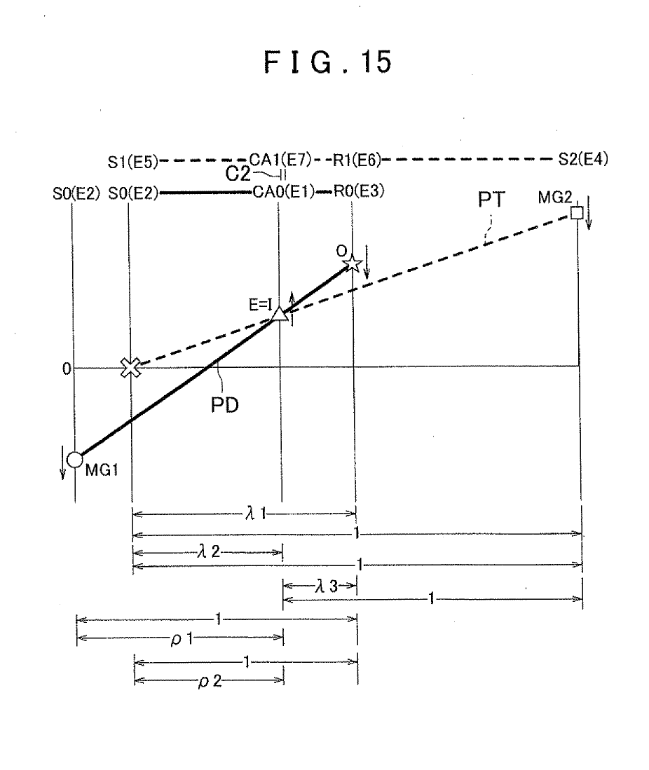

As shown in the upper portion of the velocity diagrams of FIGS. 14 and 15, the four rotary elements of the transmission device PT form a sequence of the first sun gear S1, the common carrier CA1, the common ring gear R1, and the second sun gear S2 when arranged in the order of rotational speed. Accordingly, in the embodiment, the first sun gear S1, the common carrier CA1, the common ring gear R1, and the second sun gear S2 correspond to the “first rotary element”, the “second rotary element”, the “third rotary element”, and the “fourth rotary element”, respectively, of the transmission device PT. Thus, the four rotary elements of the transmission device PT form a sequence of the speed change input rotary element E4, the first output rotary element E6, the second output rotary element E7, and the fixed rotary element E5 (which is the same as a sequence of the fixed rotary element E5, the second output rotary element E7, the first output rotary element E6, and the speed change input rotary element E4) when arranged in the order of rotational speed.

The first clutch C1 selectively drivably couples the common ring gear R1, serving as the first output rotary element a of the transmission device PT, and the output shaft O and the ring gear R0, serving as the output rotary element E3 of the power distribution device PD, to each other. Thus, in the embodiment, the first clutch C1 forms the “first engagement device EE1” according to the present invention. The common ring gear R1 of the transmission device PT, and the output shaft O and the ring gear R0 of the power distribution device PD are drivably coupled to each other with the first clutch C1 in the engaged state, and decoupled from each other with the first clutch C1 in the disengaged state. As discussed later, the first split mode is established by bringing the first clutch C1 to the engaged state. Accordingly, in the embodiment, the first clutch C1 serving as the first engagement device EE1 functions as the “first split mode engagement device” according to the present invention.

The second clutch C2 selectively drivably couples the common carrier CA1, serving as the second output rotary element E7 of the transmission device PT, and the carrier CA0, serving as the distribution input rotary element E1 of the power distribution device PD, and the input shaft I to each other. Thus, in the embodiment, the second clutch C2 forms the “second engagement device EE2” according to the present invention. The common carrier CA1 of the transmission device PT, and the carrier CA0 of the power distribution device PD and the input shaft I are drivably coupled to each other with the second clutch C2 in the engaged state, and decoupled from each other with the second clutch C2 in the disengaged state. As discussed later, the second split mode is established by bringing the second clutch C2 to the engaged state. Accordingly, in the embodiment, the second clutch C2 serving as the second engagement device EE2 functions as the “second split mode engagement device” according to the present invention.

In the embodiment, the first clutch C1 is a friction engagement device. As the first clutch C1, a multi-plate friction clutch that operates on a hydraulic pressure, for example, may be used. As in the above first embodiment described with reference to FIG. 2, the hydraulic pressure control device 35 that operates in accordance with a control command from the main control unit 31 supplies a hydraulic pressure to the first clutch C1 to control engagement and disengagement of the first clutch C1 using the hydraulic pressure. A hydraulic pressure generated by an oil pump (not shown) is supplied to the hydraulic pressure control device 35.

In the embodiment, on the other hand, the second clutch C2 serving as the second engagement device EE2 which is the second split mode engagement device is a mechanical two-way engagement device. The specific configuration of the two-way engagement device is the same as that of the second brake B2 according to the above first embodiment. The second clutch C2 according to the embodiment is provided between two rotary members that rotate relative to each other, namely the common carrier CA1, serving as the second output rotary element E7 of the transmission device PT, and the carrier CA0, serving as the distribution input rotary element E1 of the power distribution device PD. The second clutch C2 is capable of switching rotation of the common carrier CA1 serving as the second output rotary element E7 relative to the carrier CA0 serving as the distribution input rotary element E1 between a two-way allowing state in which rotation of the common carrier CA1 is allowed in both directions and a negative-direction restricting state in which such rotation is allowed only in the positive direction and restricted in the negative direction. That is, in the two-way allowing state, the second clutch C2 decouples the carrier CA0 and the common carrier CA1 from each other so that the common carrier CA1 is rotatable relative to the carrier CA0 in both directions, namely the positive direction and the negative direction. In the negative-direction restricting state, meanwhile, the second clutch C2 functions as a one-way clutch that allows rotation of the common carrier CA1 relative to the carrier CA0 only in the positive direction, and is brought to the engaged state to drivably couple the carrier CA0 and the common carrier CA1 with each other to rotate together when the common carrier CA1 is urged to rotate relative to the carrier CA0 in the negative direction. The configuration of the switching control device 36 which switches the state of the second clutch C2 and the advantages and so forth obtained by forming the second clutch C2 by a two-way engagement device are the same as those in the above first embodiment.

2-2. Configuration of Control System of Hybrid Drive Device

The control system according to the embodiment is substantially the same as the configuration shown in FIG. 2 according to the above first embodiment, except that the engagement devices are changed from the brakes B1, B2, and B3 to the clutches C1 and C2. The state of the first clutch C1 is controlled via the hydraulic pressure control device 35, and the state of the second clutch C2 is controlled via the switching control device 36. In the embodiment, in addition, the mode selection section 42 selects one of the first split mode and the second split mode as a hybrid operation mode in accordance with the vehicle speed and the required drive force using the control map 45.

2-3. Operation Modes of Hybrid Drive Device

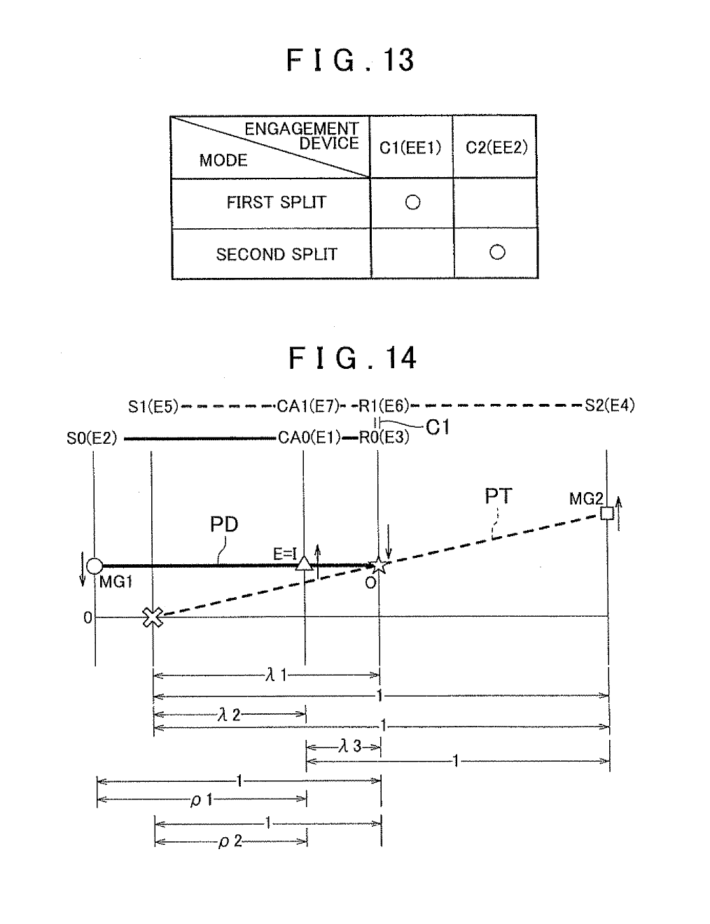

Next, the operation modes that can be established by the hybrid drive device H according to the embodiment will be described. FIG. 13 is an operation table showing the operating states of the first clutch C1 (first engagement device EE1) and the second clutch C2 (second engagement device EE2) in each operation mode. In the drawing, the symbol “∘” indicates that each engagement device is in the engaged state (for the second clutch C2, in the negative-direction restricting state), and the presence of “no symbol” indicates that each engagement device is in the disengaged state (for the second clutch C2, in the two-way allowing state).

FIGS. 14 and 15 are each a velocity diagram showing the operating states of the power distribution device PD and the transmission device PT in each operation mode. The expression rules for the velocity diagrams are the same as those for the velocity diagrams of FIG. 5 and so forth according to the above first embodiment. However, the plurality of vertical lines disposed in parallel with each other correspond to the rotary elements of the power distribution device PD and the transmission device PT. The indications “S0”, “CA0”, and “R0” provided above the vertical lines correspond to the sun gear S0, the carrier CA0, and the ring gear R0, respectively, of the power distribution device PD. The indications “S1”, “CA1”, “R1”, and “S2” correspond to the first sun gear S1, the common carrier CA1, the common ring gear R1, and the second sun gear S2, respectively, of the transmission device PT. In the drawings, the symbol “x” indicates a state in which the rotary element is fixed to the case CS serving as a non-rotary member. The symbol “=” connecting the indications of rotary elements provided above the vertical lines indicates a state in which the plurality of rotary elements are drivably coupled to each other to rotate together, and the symbol “=” accompanied by an indication “C1” or “C2” indicates a state in which the rotary elements are drivably coupled to each other to rotate together with the first clutch C1 or the second clutch C2 brought to the engaged state.

2-3-1. First Split Mode

The first split mode is an operation mode selected in a vehicle speed range lower than that for the second split mode. In the first split mode, in the state where the drive force of the internal combustion engine E is distributed by the power distribution device PD and transferred to the output shaft O, rotation of the second rotary electric machine MG2 is reduced in speed by the transmission device PT, and the drive force of the second rotary electric machine MG2 is transferred to the ring gear R0 serving as the output rotary element E3 and the output shaft O. In the first split mode, in addition, the first rotary electric machine MG1 generates a reaction force, which causes the drive force of the internal combustion engine E (input shaft I) to be transferred to the output shaft O via the power distribution device PD. Meanwhile, the second rotary electric machine MG2 operates to compensate for a shortage of the drive force from the internal combustion engine E.

As shown in FIG. 13, the first split mode is established with the first clutch C1 in the engaged state and the second clutch C2 in the disengaged state (in the embodiment, in the two-way allowing state). FIG. 14 is a velocity diagram for the first split mode. The drive force transferred from the internal combustion engine E to the carrier CA0 of the power distribution device PD via the input shaft I is distributed by the power distribution device PD and transferred to the output shaft O. At this time, the first rotary electric machine MG1 operates to receive a reaction force.

In the first split mode, by bringing the second clutch C2 to the two-way allowing state, the common carrier CA1 of the transmission device PT and the carrier CA0 of the power distribution device PD are decoupled from each other. Then, by bringing the first clutch C1 to the engaged state, the common ring gear R1 of the transmission device PT and the ring gear R0 of the power distribution device PD are drivably coupled to each other. Since the ring gear R0 of the power distribution device PD is drivably coupled to the output shaft O to rotate together with the output shaft O, rotation and the drive force of the second sun gear S2, which serves as the speed change input rotary element E4 of the transmission device PT and which rotates together with the rotor Ro2 of the second rotary electric machine MG2, are reduced in speed by the transmission device PT and transferred to the output shaft O. At this time, the “first reduced rotation”, which is reduced in speed relative to rotation of the speed change input rotary element E4 and transferred to the output shaft O, has been reduced in speed at a speed change ratio (speed reduction ratio) lower than that for the second reduced rotation to be discussed later. Accordingly, the first reduced rotation is higher in speed than the second reduced rotation for the same rotation of the speed change input rotary element E4.

2-3-2. Second Split Mode

The second split mode is an operation mode selected in a vehicle speed range higher than that for the first split mode. In the second split mode, the drive force of the internal combustion engine E is distributed by the power distribution device PD and transferred to the output shaft O, and rotation of the second rotary electric machine MG2 is reduced in speed by the transmission device PT, and the drive force of the second rotary electric machine MG2 is transferred to the carrier CA0 serving as the distribution input rotary element E1. In the second split mode, in addition, the first rotary electric machine MG1 generates a reaction force, which causes the drive force of the internal combustion engine E (input shaft I) to be transferred to the output shaft O via the power distribution device PD. The second split mode is selected in a region where the rotational speed of the output shaft O is increased and the rotational speed of the first rotary electric machine MG1 becomes negative as shown in FIG. 15. At this time, the first rotary electric machine MG1 performs power running by outputting torque in the negative direction while rotating in the negative direction, and the second rotary electric machine MG2 generates electric power by outputting torque in the negative direction while rotating in the positive direction.

As shown in FIG. 13, the second split mode is established with the second clutch C2 in the engaged state (in the embodiment, in the negative-direction restricting state) and the first clutch C1 in the disengaged state. FIG. 15 is a velocity diagram for the second split mode. In the second split mode, the vehicle speed is high, and the running torque is relatively low. As in the first split mode, the drive force transferred from the internal combustion engine E to the carrier CA0 of the power distribution device PD via the input shaft I is distributed by the power distribution device PD and transferred to the output shaft O. At this time, the first rotary electric machine MG1 operates to receive a reaction force.

In the second split mode, by bringing the first clutch C1 to the disengaged state, the common ring gear R1 of the transmission device PT and the ring gear R0 of the power distribution device PD are decoupled from each other. Then, by bringing the second clutch C2 to the engaged state, the common carrier CA1 of the transmission device PT and the carrier CA0 of the power distribution device PD are drivably coupled to each other. Since the carrier CA0 of the power distribution device PD is drivably coupled to the input shaft I to rotate together with the input shaft I, rotation and the drive force of the second sun gear S2, which serves as the speed change input rotary element E4 of the transmission device PT and which rotates together with the rotor Ro2 of the second rotary electric machine MG2, are reduced in speed by the transmission device PT and transferred to the input shaft I. At this time, the “second reduced rotation”, which is reduced in speed relative to rotation of the speed change input rotary element E4 and transferred to the input shaft I, has been reduced in speed at a speed change ratio (speed reduction ratio) higher than that for the first reduced rotation discussed above. Accordingly, the second reduced rotation is lower in speed than the first reduced rotation for the same rotation of the speed change input rotary element E4. In the second split mode, as in the above first embodiment, due to operation of the power distribution device PD and the transmission device PT, the drive force generated from the internal combustion engine E is distributed and transferred to the second rotary electric machine MG2 and the output shaft O.

The hybrid drive device H according to the embodiment also switchably includes the second split mode, and thus can suppress occurrence of power circulation when the vehicle is running at a high speed, as in the above first embodiment. In this event, in addition, rotation from the second rotary electric machine MG2 which has been reduced in speed is directly transferred to the carrier CA0, serving as the distribution input rotary element E1 of the power distribution device PD, not via the output shaft O. Accordingly, part of the drive force of the internal combustion engine E is offset by torque of the second rotary electric machine MG2, and thus torque to be output by the first rotary electric machine MG1 in order to receive a reaction force against the drive force of the internal combustion engine E can be reduced. Thus, only a small proportion of the drive force of the internal combustion engine E is converted into electric power, which improves the energy efficiency of the hybrid drive device H.

2-4. Switching Between Operation Modes

Next, mode switching between the running modes will be described. In the embodiment, basically, mode switching between the first split mode and the second split mode is performed by switching the engagement states of the first clutch C1 and the second clutch C2.

Mode switching from the first split mode to the second split mode is performed by disengaging the first clutch C1 and engaging the second clutch C2. In the embodiment, mode switching from the first split mode to the second split mode is performed at a “rotation synchronization point” at which the rotational speeds of engagement members on both sides of the second clutch C2, serving as a second split mode engagement device that is to be engaged in such mode switching, become equal to each other. In the embodiment, as described above, the second clutch C2 is an engagement device that selectively drivably couples the common carrier CA1 of the transmission device PT and the carrier CA0 of the power distribution device PD to each other. Accordingly, in the embodiment, an operating point at which the rotational speed of the common carrier CA1 of the transmission device PT and the rotational speed of the carrier CA0 of the power distribution device PD become equal to each other is defined as a rotation synchronization point, and mode switching is performed at the rotation synchronization point.

In the first split mode, the operating point of the internal combustion engine E is controlled such that the internal combustion engine E is maintained in an operating state with a suitable fuel efficiency. The rotational speed and the drive force of the carrier CA0, serving as the distribution input rotary element E1 of the power distribution device PD, are determined in accordance with the operating point of the internal combustion engine E. In the first split mode, in addition, the first rotary electric machine MG1 generates electric power by outputting torque in the negative direction while rotating in the positive direction, and the second rotary electric machine MG2 performs power running by outputting torque in the positive direction while rotating in the positive direction. When the rotational speed of the output shaft O rises along with a rise in vehicle speed, for example, the rotational speed of the first rotary electric machine MG1 is gradually lowered with the first rotary electric machine MG1 rotating in the positive direction via the power distribution device PD, and becomes zero in the course of time. The operating point at which the rotational speed of the first rotary electric machine MG1 becomes zero is defined as a “non-electric power conversion point” at which work achieved by the drive force of the internal combustion engine E is not converted into electric power (no electric power conversion is performed). In the embodiment, mode switching from the first split mode to the second split mode is not yet performed at the non-electric power conversion point.

When the vehicle speed further rises and the rotational speed of the output shaft O further rises, the rotational speed of the first rotary electric machine MG1 is gradually lowered with the first rotary electric machine MG1 rotating in the negative direction. At this time, the first rotary electric machine MG1 performs power running by outputting torque in the negative direction while rotating in the negative direction. On the other hand, the second rotary electric machine MG2 generates electric power by outputting torque in the negative direction while rotating in the positive direction. Along with a rise in rotational speed of the output shaft O, in addition, the rotational speed of the common carrier CA1 serving as the second output rotary element E7 gradually rises with the common carrier CA1 rotating in the positive direction via the transmission device PT. In the course of time, mode switching from the first split mode to the second split mode is performed at the rotation synchronization point at which the rotational speed of the common carrier CA1 serving as the second output rotary element E7 and the rotational speed of the carrier CA0 serving as the distribution input rotary element E1 become equal to each other.

To be more exact, a determination as to mode switching from the first split mode to the second split mode is made at the rotation synchronization point at which the rotational speed of the common carrier CA1 and the rotational speed of the carrier CA0 become equal to each other. In the embodiment, even after the mode switching determination is made, the rotational speed of the first rotary electric machine MG1 is further lowered, along with which the rotational speed of the carrier CA0 is further lowered. In this state, the switching control device 36 switches the state of the second clutch C2, which is formed by a two-way engagement device in the embodiment, from the two-way allowing state to the negative-direction restricting state. Thereafter, the first clutch C1 serving as the first split mode engagement device is disengaged through hydraulic pressure control performed via the hydraulic pressure control device 35. Then, the second rotary electric machine MG2 is outputting torque in the negative direction. Thus, the rotational speed of the second rotary electric machine MG2 is lowered, and the rotational speed of the common carrier CA1 serving as the second output rotary element E7 varies in the negative direction to be lowered using the first sun gear S1, which is fixed to the case CS serving as a non-rotary member, as a fulcrum. Then, when the rotational speed of the common carrier CA1 is lowered to become equal to the rotational speed of the carrier CA0, the second clutch C2 is brought to the engaged state, which drivably couples the common carrier CA1 and the carrier CA0 to each other to rotate together. Mode switching from the first split mode to the second split mode is thus completed. In the second split mode, occurrence of power circulation can be suppressed as discussed above, and the energy efficiency of the hybrid drive device H can be improved.

Thus, in the embodiment, mode switching from the first split mode to the second split mode is performed by switching the second clutch C2 from the two-way allowing state to the negative-direction restricting state with the common carrier CA1 serving as the second output rotary element E7 rotating in the positive direction relative to the carrier CA0 serving as the distribution input rotary element E1. In this way, mode switching can be performed quickly utilizing torque of the second rotary electric machine MG2 in the negative direction for electric power generation without controlling the rotational speed of the second rotary electric machine MG2 such that the rotational speed of the common carrier CA1 and the rotational speed of the carrier CA0 become equal to each other. In addition, it is not necessary to perform mode switching with the transmission device brought to the neutral state as in the related art, and occurrence of a drive force interruption during mode switching can be suppressed. Moreover, the directions of torque of both the first rotary electric machine MG1 and the second rotary electric machine MG2 are not changed before and after mode switching. Thus, no variations in torque are transferred to the output shaft O, and occurrence of a shock during mode switching can be suppressed. Furthermore, mode switching can be performed without particularly varying the operating point of the internal combustion engine E. Thus, the internal combustion engine E is maintained in an operating state with a suitable fuel efficiency, which does not deteriorate the fuel consumption rate.

On the other hand, mode switching from the second split mode to the first split mode is performed by disengaging the second clutch C2 and engaging the first clutch C1. In the embodiment, mode switching from the second split mode to the first split mode is performed at a “non-electric power conversion point” at which the rotational speed of the first rotary electric machine MG1 becomes zero and no electric power conversion is performed. Such a non-electric power conversion point is also an operating point at which torque of the second rotary electric machine MG2 becomes zero. Thus, in the embodiment, the non-electric power conversion point corresponds to a “zero torque point” according to the present invention.

In the second split mode, the first rotary electric machine MG1 performs power running by outputting torque in the negative direction while rotating in the negative direction, and the second rotary electric machine MG2 generates electric power by outputting torque in the negative direction while rotating in the positive direction. When the rotational speed of the output shaft O is lowered along with a decrease in vehicle speed, for example, the rotational speed of the ring gear R0 of the power distribution device PD, which is drivably coupled to the output shaft O to rotate together with the output shaft O, is gradually lowered, and the rotational speed of the first rotary electric machine MG1 gradually rises with the first rotary electric machine MG1 rotating in the negative direction via the power distribution device PD. In the course of time, a “rotation synchronization point” at which the rotational speed of the ring gear R0 of the power distribution device PD and the rotational speed of the common ring gear R1 of the transmission device PT become equal to each other is reached. In the embodiment, mode switching from the second split mode to the first split mode is not yet performed at the rotation synchronization point.

When the vehicle speed is further lowered and the rotational speed of the output shaft O is further lowered, the rotational speed of the first rotary electric machine MG1 gradually rises with the first rotary electric machine MG1 rotating in the negative direction via the power distribution device PD. Then, after the above rotation synchronization point is passed, the rotational speed of the first rotary electric machine MG1 becomes zero in the course of time. The operating point at which the rotational speed of the first rotary electric machine MG1 becomes zero is defined as a “non-electric power conversion point” at which work achieved by the drive force of the internal combustion engine E is not converted into electric power (no electric power conversion is performed). In the embodiment, mode switching from the second split mode to the first split mode is performed at the non-electric power conversion point.

To be more exact, a determination as to mode switching from the second split mode to the first split mode is made at the non-electric power conversion point at which the rotational speed of the first rotary electric machine MG1 becomes zero. In the embodiment, after the mode switching determination is made, the rotational speed of the first rotary electric machine MG1 is maintained at zero for a predetermined period of time. At the same time as the rotational speed of the first rotary electric machine MG1 becomes zero, torque of the second rotary electric machine MG2 also becomes zero, and is maintained at zero for a predetermined period of time thereafter. In this state, the switching control device 36 switches the state of the second clutch C2, which is formed as a two-way engagement device in the embodiment, from the negative-direction restricting state to the two-way allowing state. Thereafter, the first clutch C1 serving as the first split mode engagement device is engaged through hydraulic pressure control performed via the hydraulic pressure control device 35. Then, the common ring gear R1 serving as the first output rotary element E6 and the ring gear R0 serving as the output rotary element E3 are drivably coupled to each other to rotate together through the first clutch C1. Mode switching from the second split mode to the first split mode is thus completed.

In the embodiment, as described above, mode switching from the second split mode to the first split mode is performed with the rotational speed of the first rotary electric machine MG1 being zero, that is, with the second rotary electric machine MG2 outputting no torque (zero torque). In this way, no variations in torque of the second rotary electric machine MG2 are transferred to the output shaft O, and occurrence of a shock during mode switching can be suppressed. Furthermore, mode switching can be performed without particularly varying the operating point of the internal combustion engine E. Thus, the internal combustion engine E is maintained in an operating state with a suitable fuel efficiency, which does not deteriorate the fuel consumption rate.

Also in the embodiment, as has been described above, the relationship between the numbers of teeth of the predetermined rotary elements of the power distribution device PD and the transmission device PT is set such that the first relative rotational speed ratio ρ1 is higher than the second relative rotational speed ratio ρ2. Therefore, mode switching between the first split mode and the second split mode can be performed at a selected one of two switching points, namely a rotation synchronization point and a non-electric power conversion point (zero torque point). In the embodiment, mode switching from the first split mode to the second split mode is performed at the rotation synchronization point, which is one of the two switching points, and mode switching from the second split mode to the first split mode is performed at the non-electric power conversion point (zero torque point), which is the other of the two switching points. That is, mode switching from the first split mode to the second split mode is performed at the rotation synchronization point after the non-electric power conversion point (zero torque point) is passed, and mode switching from the second split mode to the first split mode is performed at the non-electric power conversion point (zero torque point) after the rotation synchronization point is passed. In the embodiment, by setting the switching points as described above, hysteresis is provided in mode switching between the first split mode and the second split mode. Accordingly, it is possible to prevent mode switching from being performed frequently in a short period of time, and to avoid giving the driver of the vehicle a sense of busyness due to such mode switching.

### Other Embodiments

Finally, hybrid drive devices according to other embodiments of the present invention will be described. A characteristic configuration disclosed is each of the following embodiments may be applied not only to that particular embodiment but also in combination with a characteristic configuration disclosed in any other embodiment unless any contradiction occurs.

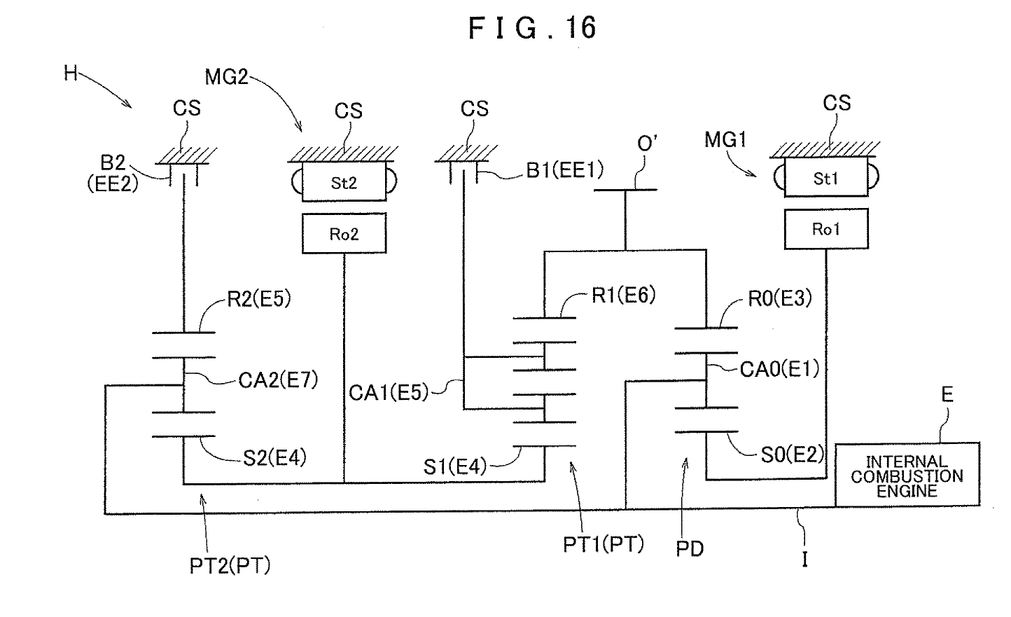

(1) The specific configurations of the hybrid drive device H described in each of the above embodiments, that is, the specific configuration of the transmission device PT, the configuration of coupling between the power distribution device PD and the transmission device PT, the configuration of coupling of the engagement devices to the rotary elements of the transmission device PT, and so forth, are merely exemplary, and any configuration other than the above configurations that implements the configuration according to the present invention falls within the scope of the present invention. For example, in one suitable embodiment of the present invention, the hybrid drive device H is configured as shown in FIG. 16. In the hybrid drive device H shown in FIG. 16, components having functions equivalent to those of the components according to the above first embodiment or the above second embodiment are denoted by the same reference numerals. In the hybrid drive device H, the transmission device PT is formed by a combination of a first differential gear device PT1 which is a double-pinion type planetary gear mechanism and a second differential gear device PT2 which is a single-pinion type planetary gear mechanism, each of which includes three rotary elements. A ring gear R0 of the power distribution device PD serving as the output rotary element E3 and a first ring gear R1 of the transmission device PT (in the embodiment, the first differential gear device PT1) serving as the first output rotary element E6 are drivably coupled to an output gear O′ to rotate together with the output gear O′ serving as an output member disposed between the first rotary electric machine MG1 and the second rotary electric machine MG2 in the axial direction of the input shaft I and on the radially outer side of the power distribution device PD and the first differential gear device PT1. Although not shown, rotation and a drive force transferred to the output gear O′ are transferred to the wheel side via a counter gear mechanism and an output differential gear device. Such a configuration is suitable as a configuration of the hybrid drive device H to be mounted on FF (Front-Engine Front-Drive) vehicles, for example.

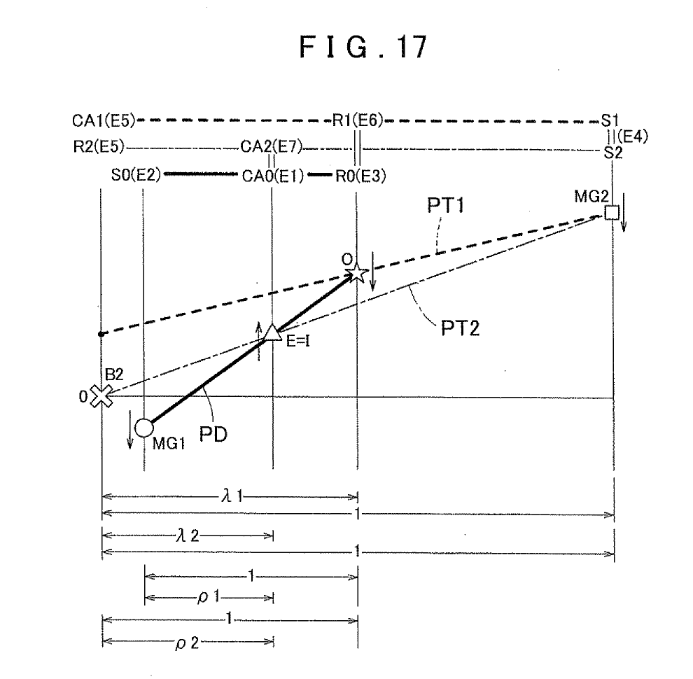

(2) In each of the above embodiments, the first relative rotational speed ratio ρ1 is set to be higher than the second relative rotational speed ratio ρ2. However, the present invention is not limited thereto. That is, in one suitable embodiment of the present invention, the first relative rotational speed ratio ρ1 is set to be lower than the second relative rotational speed ratio ρ2. FIG. 17 is a velocity diagram for the second split mode in the hybrid drive device H shown in FIG. 16. In the hybrid drive device H, as also shown in the drawing, the first relative rotational speed ratio ρ1 is set to be lower than the second relative rotational speed ratio ρ2. In this case, the vertical line corresponding to a first carrier CA1 and a second ring gear R2 each serving as the fixed rotary element E5 is provided opposite the vertical line corresponding to the ring gear R0 serving as the output rotary element E3 and the first ring gear R1 serving as the first output rotary element E6 and the vertical line corresponding to a carrier CA0 serving as the distribution input rotary element E1 and a second carrier CA2 serving as the second output rotary element E7 with respect to the vertical line corresponding to a sun gear S0 serving as the reaction force rotary element E2.

Also in this case, mode switching between the first split mode and the second split mode can be performed at a selected one of two switching points, namely a rotation synchronization point and a non-electric power conversion point. In this case, mode switching from the first split mode to the second split mode may be performed at the non-electric power conversion point, which is one of the two switching points, and mode switching from the second split mode to the first split mode may be performed at the rotation synchronization point, which is the other of the two switching points. Such a configuration is suitable because hysteresis can be provided in mode switching between the first split mode and the second split mode as in each of the above embodiments. Thus, if the first relative rotational speed ratio ρ1 and the second relative rotational speed ratio ρ2 are at least set to be different from each other, it is possible to prevent mode switching from being performed frequently in a short period of time by providing the above hysteresis, and to avoid giving the driver of the vehicle a sense of busyness due to such mode switching.

(3) In each of the above embodiments, mode switching from the second split mode to the first split mode is performed at a “non-electric power conversion point” at which the rotational speed of the first rotary electric machine MG1 becomes zero and no electric power conversion is performed, and at which torque of the second rotary electric machine MG2 becomes zero. However, the present invention is not limited thereto. That is, in one suitable embodiment of the present invention, mode switching from the second split mode to the first split mode is performed at a “zero torque point” that is not a “non-electric power conversion point”. For example, in the case where torque of the second rotary electric machine MG2 is controlled to zero with the rotational speed of the first rotary electric machine MG1 not being zero, mode switching from the second split mode to the first split mode may be performed at an operating point at which the rotational speed of the first rotary electric machine MG1 is not zero and torque of the second rotary electric machine MG2 becomes zero.

(4) In the above first embodiment, the second brake B2 serving as the second engagement device EE2 (second split mode engagement device) is a mechanical two-way engagement device, and the first brake B1 serving as the first engagement device EE1 (first split mode engagement device) and the third brake B3 serving as the third engagement device EE3 are each a friction engagement device. However, the present invention is not limited thereto. That is, the specific configurations of the first brake B1, the second brake B2, and the third brake B3 may be determined appropriately, and various types of engagement devices such as a friction engagement device, a mechanical two-way engagement device, and a meshing type engagement device may be used in any combination. Likewise, in the above second embodiment, the second clutch C2 serving as the second engagement device EE2 (second split mode engagement device) is a mechanical two-way engagement device, and the first clutch C1 serving as the first engagement device EE1 (first split mode engagement device) is a friction engagement device. However, the present invention is not limited thereto. That is, the specific configurations of the first clutch C1 and the second clutch C2 may be determined appropriately, and various types of engagement devices such as a friction engagement device, a mechanical two-way engagement device, and a meshing type engagement device may be used in any combination.

(5) In the above first embodiment, the second brake B2 serving as the second engagement device EE2 (second split mode engagement device) formed using a two-way engagement device is switchable between a two-way allowing state in which rotation of the third ring gear R3 relative to the case CS is allowed in both directions and a positive-direction restricting state in which such rotation is allowed only in the negative direction and restricted in the positive direction. However, the present invention is not limited thereto. That is, in one suitable embodiment of the present invention, the second brake B2 is further switchable to at least one of a negative-direction restricting state in which such rotation is allowed only in the positive direction and restricted in the negative direction and a two-direction restricting state in which such rotation is restricted in both directions, for example, in addition to the two-way allowing state and the positive-direction restricting state. Likewise, in the above second embodiment, the second clutch C2 serving as the second engagement device EE2 (second split mode engagement device) formed using a two-way engagement device is switchable between a two-way allowing state in which rotation of the common carrier CA1 relative to the carrier CA0 is allowed in both directions and a negative-direction restricting state in which such rotation is allowed only in the positive direction and restricted in the negative direction. However, the present invention is not limited thereto. That is, in one suitable embodiment of the present invention, the second clutch C2 is switchable to at least one of a positive-direction restricting state in which such rotation is allowed only in the negative direction and restricted in the positive direction and a two-direction restricting state in which such rotation is restricted in both directions, for example, in addition to the two-way allowing state and the negative-direction restricting state.

(6) In the above first embodiment, the second brake B2 serving as the second engagement device EE2 (second split mode engagement device) is formed using a two-way engagement device, and mode switching from the first split mode to the second split mode is completed by further lowering the rotational speed of the third ring gear R3 after a rotation synchronization point is reached, and thereafter raising the rotational speed of the third ring gear R3 after bringing the second brake B2 to the positive-direction restricting state. However, the present invention is not limited thereto. That is, in one suitable embodiment of the present invention, such mode switching is completed by bringing the second brake B2 to the positive-direction restricting state immediately when the rotation synchronization point is reached, for example. Likewise, in the above second embodiment, the second clutch C2 serving as the second engagement device EE2 (second split mode engagement device) is formed using a two-way engagement device, and mode switching from the first split mode to the second split mode is completed by further lowering the rotational speed of the carrier CA0 after a rotation synchronization point is reached, and thereafter lowering the rotational speed of the common carrier CA1 after bringing the second clutch C2 to the negative-direction restricting state. However, the present invention is not limited thereto. That is, in one suitable embodiment of the present invention, such mode switching is completed by bringing the second clutch C2 to the negative-direction restricting state immediately when the rotation synchronization point is reached, for example.

Such mode switching is particularly suitable for a case where the second brake B2 or the second clutch C2 serving as the second engagement device EE2 (second split mode engagement device) is formed using a friction engagement device. That is, in the case where the hybrid drive device H is formed using a friction engagement device as the second brake B2 or the second clutch C2, it is suitable that mode switching from the first split mode to the second split mode is completed by engaging the second brake B2 or the second clutch C2 through hydraulic pressure control performed via the hydraulic pressure control device 35 immediately when the rotation synchronization point is reached.

(7) In the above first embodiment, regarding the modes in which the hybrid drive device H is operable, the hybrid drive device H switchably includes three modes, namely the first split mode, the second split mode, and the third split mode. In the above second embodiment, the hybrid drive device H switchably includes two modes, namely the first split mode and the second split mode. However, the present invention is not limited thereto. That is, in one suitable embodiment of the present invention, the hybrid drive device H further switchably includes at least one of a parallel mode in which both rotation of the input shaft I (internal combustion engine E) and rotation of the second rotary electric machine MG2 which has been reduced in speed are transferred to the output shaft O with both the first engagement device EE1 and the second engagement device EE2 in the engaged state and a second rotary electric machine decoupling mode in which only rotation of the input shaft I (internal combustion engine E) is transferred to the output shaft O with both the first engagement device EE1 and the second engagement device EE2 in the disengaged state, in addition to the above modes. In another suitable embodiment of the present invention, the hybrid drive device H further switchably includes modes other than those described above.

(8) Also regarding other configurations, the embodiments disclosed herein are examples in all respects, and the present invention is not limited to such embodiments. That is, it is a matter of course that a configuration obtained by appropriately modifying part of a configuration not disclosed in the claims of the present invention also falls within the technical scope of the present invention as long as the obtained configuration includes a configuration disclosed in the claims or a configuration equivalent thereto.

The present invention can be suitably utilized as a drive device for a hybrid vehicle including two rotary electric machines as drive force sources in addition to an internal combustion engine.

What is claimed is:

1. A hybrid drive device that includes an input member drivably coupled to an internal combustion engine, an output member drivably coupled a wheel, a first rotary electric machine, a second rotary electric machine, and a power distribution device including at least three rotary elements, and in which a distribution input rotary element, a reaction force rotary element, and an output rotary element of the power distribution device are drivably coupled to the input member, the first rotary electric machine, and the output member, respectively, the hybrid drive device comprising:
a transmission device including at least four rotary elements forming a sequence of a speed change input rotary element, a first output rotary element, a second output rotary element, and a fixed rotary element when arranged in the order of rotational speed, wherein
the speed change input rotary element is drivably coupled to the second rotary electric machine, and the fixed rotary element is always or selectively fixed to a non-rotary member,
the hybrid drive device switchably includes a first split mode in which the speed change input rotary element and the output rotary element are drivably coupled to each other via the first output rotary element, and a second split mode in which the speed change input rotary element and the distribution input rotary element are drivably coupled to each other via the second output rotary element, and
a first relative rotational speed ratio and a second relative rotational speed ratio are set to be different from each other, the first relative rotational speed ratio being a ratio of a relative rotational speed of the distribution input rotary element to a relative rotational speed of the output rotary element determined on the basis of a rotational speed of the reaction force rotary element, and the second relative rotational speed ratio being a ratio of a relative rotational speed of the second output rotary element to a relative rotational speed of the first output rotary element determined on the basis of a rotational speed of the fixed rotary element.

2. The hybrid drive device according to claim 1, further comprising:
a first split mode engagement device that is brought to an engaged state to establish the first split mode, and a second split mode engagement device that is engaged to establish the second split mode, wherein
defining an operating point at which rotational speeds of engagement members on both sides of one of the first split mode engagement device and the second split mode engagement device that is to be engaged in mode switching are equal to each other as a rotation synchronization point, and defining an operating point at which torque of the second rotary electric machine becomes zero as a zero torque point,
mode switching from the first split mode to the second split mode is performed at one of the rotation synchronization point and the zero torque point, and
mode switching from the second split mode to the first split mode is performed at the other of the rotation synchronization point and the zero torque point.

3. The hybrid drive device according to claim 2, wherein
at least the second split mode engagement device which is brought to the engaged state to establish the second split mode is a two-way engagement device that switchably includes at least two states including a state in which rotation of the engagement member on one side of the second split mode engagement device relative to the engagement member on the other side is allowed in both directions and a state in which such rotation is allowed only in one direction and restricted in the other direction.

4. The hybrid drive device according to claim 3, wherein
the second split mode engagement device is switchable between a two-way allowing state in which rotation of the fixed rotary element relative to a non-rotary member is allowed in both directions and a positive-direction restricting state in which such rotation is allowed only in a negative direction and restricted in a positive direction, and
mode switching from the first split mode to the second split mode is performed by switching the second split mode engagement device from the two-way allowing state to the positive-direction restricting state with the fixed rotary element rotating in the negative direction.

5. The hybrid drive device according to claim 4, further comprising:
a third split mode in which the speed change input rotary element and the output rotary element are drivably coupled to each other via the first output rotary element, and in which rotation of the speed change input rotary element is reduced in speed at a speed change ratio higher than a speed change ratio in the first split mode, and then transferred to the output rotary element.

6. The hybrid drive device according to claim 5, wherein
the transmission device is formed by a first differential gear device including four rotary elements forming a sequence of a first rotary element, a second rotary element, a third rotary element, and a fourth rotary element when arranged in the order of rotational speed, and a second differential gear device including three rotary elements forming a sequence of a first rotary element, a second rotary element, and a third rotary element when arranged in the order of rotational speed,
the third rotary element of the first differential gear device is drivably coupled to the output member,
the fourth rotary element of the first differential gear device is drivably coupled to the second rotary electric machine,
the second rotary element of the second differential gear device is drivably coupled to the input member,
the third rotary element of the second differential gear device is drivably coupled to the second rotary electric machine, and
the hybrid drive device further includes:
a first engagement device that selectively fixes the first rotary element of the first differential gear device to a non-rotary member;
a second engagement device that selectively fixes the first rotary element of the second differential gear device to a non-rotary member; and
a third engagement device that selectively fixes the second rotary element of the first differential gear device to a non-rotary member.

7. The hybrid drive device according to claim 6, wherein
the first differential gear device is a Ravigneaux type planetary gear device including four rotary elements forming a sequence of a first sun gear, a common carrier, a common ring gear, and a second sun gear when arranged in the order of rotational speed, and the first rotary element, the second rotary element, the third rotary element, and the fourth rotary element of the first differential gear device are the second sun gear, the common ring gear, the common carrier, and the first sun gear, respectively, and
the second differential gear device is a single-pinion type planetary gear device in which a ring gear, a carrier, and a sun gear are the first rotary element, the second rotary element, and the third rotary element, respectively, of the second differential gear device.

8. The hybrid drive device according to claim 7, wherein
the first relative rotational speed ratio is set to be higher than the second relative rotational speed ratio.

9. The hybrid drive device according to claim 2, wherein
the transmission device is a differential gear device including four rotary elements forming a sequence of a first rotary element, a second rotary element, a third rotary element, and a fourth rotary element when arranged in the order of rotational speed,
the first rotary element of the differential gear device is fixed to a non-rotary member, and the fourth rotary element of the differential gear device is drivably coupled to the second rotary electric machine, and
the hybrid drive device further includes:
a first engagement device that selectively drivably couples the third rotary element of the differential gear device and the output member to each other; and
a second engagement device that selectively drivably couples the second rotary element of the differential gear device and the input member to each other.

10. The hybrid drive device according to claim 9, wherein
the transmission device is a Ravigneaux type planetary gear device including four rotary elements forming a sequence of a first sun gear, a common carrier, a common ring gear, and a second sun gear when arranged in the order of rotational speed, and the first rotary element, the second rotary element, the third rotary element, and the fourth rotary element of the transmission device are the first sun gear, the common carrier, the common ring gear, and the second sun gear, respectively.

11. The hybrid drive device according to claim 10, wherein
the first relative rotational speed ratio is set to be higher than the second relative rotational speed ratio.

12. The hybrid drive device according to claim 1, wherein
at least the second split mode engagement device which is brought to the engaged state to establish the second split mode is a two-way engagement device that switchably includes at least two states including a state in which rotation of the engagement member on one side of the second split mode engagement device relative to the engagement member on the other side is allowed in both directions and a state in which such rotation is allowed only in one direction and restricted in the other direction.

13. The hybrid drive device according to claim 12, wherein
the second split mode engagement device is switchable between a two-way allowing state in which rotation of the fixed rotary element relative to a non-rotary member is allowed in both directions and a positive-direction restricting state in which such rotation is allowed only in a negative direction and restricted in a positive direction, and
mode switching from the first split mode to the second split mode is performed by switching the second split mode engagement device from the two-way allowing state to the positive-direction restricting state with the fixed rotary element rotating in the negative direction.

14. The hybrid drive device according to claim 13, further comprising:
a third split mode in which the speed change input rotary element and the output rotary element are drivably coupled to each other via the first output rotary element, and in which rotation of the speed change input rotary element is reduced in speed at a speed change ratio higher than a speed change ratio in the first split mode, and then transferred to the output rotary element.

15. The hybrid drive device according to claim 14, wherein
the transmission device is formed by a first differential gear device including four rotary elements forming a sequence of a first rotary element, a second rotary element, a third rotary element, and a fourth rotary element when arranged in the order of rotational speed, and a second differential gear device including three rotary elements forming a sequence of a first rotary element, a second rotary element, and a third rotary element when arranged in the order of rotational speed,
the third rotary element of the first differential gear device is drivably coupled to the output member,
the fourth rotary element of the first differential gear device is drivably coupled to the second rotary electric machine,
the second rotary element of the second differential gear device is drivably coupled to the input member,
the third rotary element of the second differential gear device is drivably coupled to the second rotary electric machine, and
the hybrid drive device further includes:
a first engagement device that selectively fixes the first rotary element of the first differential gear device to a non-rotary member;
a second engagement device that selectively fixes the first rotary element of the second differential gear device to a non-rotary member; and
a third engagement device that selectively fixes the second rotary element of the first differential gear device to a non-rotary member.

16. The hybrid drive device according to claim 15, wherein
the first differential gear device is a Ravigneaux type planetary gear device including four rotary elements forming a sequence of a first sun gear, a common carrier, a common ring gear, and a second sun gear when arranged in the order of rotational speed, and the first rotary element, the second rotary element, the third rotary element, and the fourth rotary element of the first differential gear device are the second sun gear, the common ring gear, the common carrier, and the first sun gear, respectively, and
the second differential gear device is a single-pinion type planetary gear device in which a ring gear, a carrier, and a sun gear are the first rotary element, the second rotary element, and the third rotary element, respectively, of the second differential gear device.

17. The hybrid drive device according to claim 16, wherein
the first relative rotational speed ratio is set to be higher than the second relative rotational speed ratio.

18. The hybrid drive device according to claim 12, wherein
the transmission device is a differential gear device including four rotary elements forming a sequence of a first rotary element, a second rotary element, a third rotary element, and a fourth rotary element when arranged in the order of rotational speed,
the first rotary element of the differential gear device is fixed to a non-rotary member, and the fourth rotary element of the differential gear device is drivably coupled to the second rotary electric machine, and
the hybrid drive device further includes:
a first engagement device that selectively drivably couples the third rotary element of the differential gear device and the output member to each other; and
a second engagement device that selectively drivably couples the second rotary element of the differential gear device and the input member to each other.

19. The hybrid drive device according to claim 18, wherein
the transmission device is a Ravigneaux type planetary gear device including four rotary elements forming a sequence of a first sun gear, a common carrier, a common ring gear, and a second sun gear when arranged in the order of rotational speed, and the first rotary element, the second rotary element, the third rotary element, and the fourth rotary element of the transmission device are the first sun gear, the common carrier, the common ring gear, and the second sun gear, respectively.

20. The hybrid drive device according to claim 19, wherein
the first relative rotational speed ratio is set to be higher than the second relative rotational speed ratio.

21. The hybrid drive device according to claim 1, further comprising:
a third split mode in which the speed change input rotary element and the output rotary element are drivably coupled to each other via the first output rotary element, and in which rotation of the speed change input rotary element is reduced in speed at a speed change ratio higher than a speed change ratio in the first split mode, and then transferred to the output rotary element.

22. The hybrid drive device according to claim 1, wherein
the transmission device is formed by a first differential gear device including four rotary elements forming a sequence of a first rotary element, a second rotary element, a third rotary element, and a fourth rotary element when arranged in the order of rotational speed, and a second differential gear device including three rotary elements forming a sequence of a first rotary element, a second rotary element, and a third rotary element when arranged in the order of rotational speed,
the third rotary element of the first differential gear device is drivably coupled to the output member,
the fourth rotary element of the first differential gear device is drivably coupled to the second rotary electric machine,
the second rotary element of the second differential gear device is drivably coupled to the input member,
the third rotary element of the second differential gear device is drivably coupled to the second rotary electric machine, and
the hybrid drive device further includes:
a first engagement device that selectively fixes the first rotary element of the first differential gear device to a non-rotary member;
a second engagement device that selectively fixes the first rotary element of the second differential gear device to a non-rotary member; and
a third engagement device that selectively fixes the second rotary element of the first differential gear device to a non-rotary member.

23. The hybrid drive device according to claim 1, wherein
the transmission device is a differential gear device including four rotary elements forming a sequence of a first rotary element, a second rotary element, a third rotary element, and a fourth rotary element when arranged in the order of rotational speed,
the first rotary element of the differential gear device is fixed to a non-rotary member, and the fourth rotary element of the differential gear device is drivably coupled to the second rotary electric machine, and
the hybrid drive device further includes:
a first engagement device that selectively drivably couples the third rotary element of the differential gear device and the output member to each other; and
a second engagement device that selectively drivably couples the second rotary element of the differential gear device and the input member to each other.

24. The hybrid drive device according to claim 1 wherein
the first relative rotational speed ratio is set to be higher than the second relative rotational speed ratio

25. The hybrid drive device according to claim 2 wherein
the first relative rotational speed ratio is set to be higher than the second relative rotational speed ratio
